(19) United States
(12) Patent Application Publication
(10) Pub. No.: US 2008/0215370 A1
(43) Pub. Date: Sep. 4, 2008

(54) System and Method for Providing Remote Users with Reports and Analyses Based on User Data and Adaptable Reporting with the Ability to Alter, Modify or Augment Such Reports and Analyses through Web-Based Technology

(75) Inventors: Thomas Dent, Park Ridge, IL (US); Theresa Hush, Chicago, IL (US); William Aube, Chicago, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: ICLOPS, LLC, Chicago, IL (US)

(21) Appl. No.: 12/034,539

(22) Filed: Feb. 20, 2008

Related U.S. Application Data
(63) Continuation-in-part of application No. 10/713,892, filed on Nov. 14, 2003.
(60) Provisional application No. 60/514,220, filed on Oct. 24, 2003.
(60) Provisional application No. 60/890,766, filed on Feb. 20, 2007.

(51) Int. Cl. G06Q 50/00

(52) U.S. Cl. 705/3

(57) ABSTRACT

A system and method for providing remote users with reports and analyses based on user data is disclosed. One such report is a physician score report that includes a physician score. The physician score is determined by analyzing data from multiple data sources. Another such report displays the status of all patients assigned to all measures for a physician. A user may use the report to enter quality codes and clinical values in response to a measure in which a patient has been included.

### PRIORITY

This application claims priority to U.S. Provisional Application No. 60/890,766, entitled “System and Method for Providing Remote Users With Reports and Analyses Based On User Data and Adaptable Reporting With the Ability to Alter, Modify or Augment Such Reports and Analyses Through Web-Based Technology” filed Feb. 20, 2007, the contents of which are incorporated by reference. This application is also a continuation-in-part of and claims priority to U.S. patent application Ser. No. 10/713,892, “System and Method for Providing Remote Users With Reports and Analyses Based On User Data and Adaptable Reporting With the Ability to Alter, Modify or Augment Such Reports and Analyses Through Web-Based Technology,” filed Nov. 14, 2003, which claimed priority to U.S. Provisional Application No. 60/514,220, both of which are incorporated by reference.

### FIELD

This invention is directed generally to a system and method of providing reports and analyses through web-based technology, and more particularly to a system and method of providing remote users in the health care or other professional industry, via their computer web browser, with reports and analyses related to physician or provider performance based on data from information systems in a fashion that allows them to alter, modify or augment the contents and presentation of such reports and analyses by the use of a web application utilizing database technology.

### BACKGROUND

The current healthcare environment is placing tremendous financial pressures on physicians and other healthcare businesses. Without the ability to alter the external health care market forces, physicians must use the tools deployed by more traditional businesses to understand how their practices operate and how the market environment is affecting their businesses. Practice success, in large part, depends on access to information such as patient flow, patient satisfaction, physician productivity, contract profitability, operating costs, and clinical quality. These performance measures are not traditionally addressed by in-house systems.

In addition to financial issues, the regulatory and market environment of health care now requires greater clinical understanding and more sophistication in the management of patients with complex clinical problems. Health care enterprises are measured by insurance plans and governmental bodies on their ability to provide measurable quality care to discrete populations, such as diabetic, hypertensive, and asthmatic patients, and to provide screening programs appropriate to age and gender.

Physician practices currently lack the tools needed to efficiently respond to these issues. Typically the only method of compiling financial and market data is through the practice's billing or clinical information systems. Even when used (some practices outsource billing functions), these systems are usually designed for transactional processing and provide limited management reporting and little, if any, practice profile data. Tools for the management of Clinical Quality are even scarcer. For the more sophisticated systems with database repositories and pre-programmed reporting capabilities, programming staff are still required to write and reformat static reports for true analytical purposes, which can be very costly. As a result, practices of all sizes are lacking the information critical to success and sustainability.

Accordingly, there is a need to provide a system and method of supplying practice professionals with critical analysis capabilities and data capture tools so that they may understand their business operations and improve business performance, and to provide outside entities with more accurate evaluations of clinical quality. There is also a need to assist medical providers in the communication and provision of services to patients and to increase the quality of care provided to patients. It would be useful to provide these capabilities while using data from client practice management systems and other sources of client data, and to insure that all information transferred from one location to another is done so in accordance with the Health Insurance Portability and Accountability Act of 1996 (HIPAA) privacy regulations.

Furthermore, it would be useful to provide businesses with analytical capabilities that are timely, useful and that require little (and preferably no) additional programming by client staff or others and allow users to quickly explore key issues. Ideally, these analytical capabilities would be available over a commonly available resource such as a web browser accessing the Internet or corporate intranet. There is also a need to deliver a user interface that is easy to use, yet capable of answering a variety of queries against the source data, with a system that is capable of providing analytical capabilities to multiple clients.

### SUMMARY

One embodiment of the invention is directed to creating meaningful business and clinical quality analysis tools based on data from a client's practice management system, external billing systems, external insurance systems, external pharmacy systems, external laboratory systems, and other sources of client data; and providing such clients at remote locations with web-based access to those tools. At the core of the embodiment is the presence of an analysis database that is used to develop custom OLAP cubes built especially to address business and clinical analyses and to serve as a platform for enhanced clinical quality measurement. For clinical quality measurement, the analysis database feeds analyzed patient and practice information into a Master Patient Registry (MPR) database. The MPR database, in turn, grants the ability to accurately identify and evaluate patient groups, as well as generate mechanisms for validation and the capture of additional clinical data.

The following describes the method of creating the OLAP cubes and the MPR database. Business and clinical performance indicators used by external experts, purchasers of health care, and patients were analyzed and itemized to determine what queries may be needed by a practice. These performance indicators included financial performance measures used by accountants, billing agents, and other organizations assessing the financial health of the customer entity; financial and other measures used by provider contracting organizations in assessing the impact of contracts between health care payers and the customer entity; market performance measures used to assess the growth potential and survivability of the customer entity; productivity and operational performance measures used to determine the efficiency of the operation of the customer entity; and clinical performance measures used to evaluate compliance with established clinical protocols and accepted quality of care guidelines.

Transactional data needed to develop queries that result in the performance analyses are identified and listed. The client data is then combined with the performance identifiers to create a standard dataset for extraction from the sources of client data. The standard dataset is then organized into OLAP datamarts and cubes to create modules, dimensions, and measures by which the performance analysis may be displayed to customers. The result of this process is an analytical tool that can be customized for individual customers, but which contains a model for organizing and displaying analyses of business and clinical performance.

Transactional data from the sources of client data is copied or extracted into a file or set of files. The system that stores these files possesses a client application for encrypted file transfer, and is connected to a transmission system (such as the Internet or a corporate local area network (LAN)) via a first transmit/receive device (such as an Ethernet network interface card (NIC)). Data files are sent from the source system to a host server. Data files are analyzed and a relational database is created. The relational database is further analyzed to determine the possible analytical content. The analysis database (also technically termed as datamarts) is created based on what analytical content is possible, according to the processes previously determined to be needed by a practice and for clinical quality evaluation. The analysis database is created to respond to queries in the areas of financial performance, patient flow, patient satisfaction, physician productivity, contract profitability, and clinical quality. Cubes are then created based on the analysis database.

The analysis database is structured to contain not only data that has been sourced from client data, but registry information and quality measurements as well. The MPR database imports data from the datamarts and evaluates what data has changed since the previous import. The MPR database then uses business rules to determine how the registries will be modified by the new information. Additionally, some registry information can be corrected through the use of a secure web-based application interface. The MPR database also uses the registry information to determine if prompt-based data capture techniques are applicable, and generate the needed materials if so.

Data within the analysis database may be used to calculate a score that provides an indication of a physician's performance. The physician score is determined by analyzing data from multiple data sources. The data is stored within a patient registry and filtered prior to analysis. The physician score may be determined by examining critical points of care to patients who represent a critical or measurable component of the physician's patient base.

The following describes the method by which a user gains access to the OLAP cubes or registry validation functions and makes use of them via a web application. The user logs onto the web page, selects the appropriate application, and enters authentication information, which may vary from entering a password to more complex entry authorization protocols. The user may access the web site by using a computer to open a web browser and entering a universal resource locator (URL) for the web server hosting a web application. The web server sends a homepage to the web browser of the user via a transmission system. The user accesses the web application via the web browser, and the web server sends a login form in which the user enters his credentials/password to obtain access.

Once accessed, the web server sends a dynamic custom application page to the user. The user then performs application options, such as alter, modify, and augment the contents of views. For example, the user may use the application to review the status of all patients assigned to all measures for a physician. Additionally, the user may use the application to enter quality codes and clinical values in response to a measure in which a patient has been included. In this manner, use of the application enables users to understand and maintain their business and clinical operations, and to improve business performance and patient care.

Security against unauthorized access of data as it is passing though the transmission system is ensured by the use of encryption/decryption software as provided by the web server/browser and other file transfer server/client software. This may ensure that only an authorized user can read, transmit, and receive data to and from the application system.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

An example of the present invention is described herein with reference to the drawings, in which:

FIG. 1 is a block diagram of a system for data extraction and conversion, according to an example;

FIG. 2 is a table of data fields for client data, according to an example;

FIG. 3 is a flowchart of a method of data extraction and conversion using the system depicted in FIG. 1, according to an example;

FIG. 4 is a block diagram of a system for client access to analytical data and patient registries, according to an example;

FIG. 5 is a flow chart of a method of accessing analytical data and patient registries using the system depicted in FIG. 4, according to an example;

FIG. 6 is a screen shot of a sample view, according to an example;

FIG. 6A is a screen shot of a web page for entering user credentials, according to an example;

FIG. 6B is a screen shot of a web page for selecting an application component, according to an example;

FIG. 6C is a screen shot of a web page for reviewing the status of all patients assigned to all measures for a physician, according to an example;

FIG. 6D is a screen shot of a web page for reviewing the status of all measures for a patient, as well as for the input of new information and the correction of erroneous information, according to an example;

FIG. 6E is a screen shot of a web page for reviewing the status of all measures for a patient, as well as for the input of new information and the correction of erroneous information, according to an example;

FIG. 6F is a screen shot of a web page for entering quality codes in response to a measure which a patient has been included; according to an example;

FIG. 6G is a screen shot of a web page for entering quality codes that pertain to specific clinical metrics in response to a measure which a patient has been included; according to an example;

FIG. 6H is a screen shot of a web page for reviewing the data history for a patient as well as for the input of new information and the correction of erroneous information, according to an example;

FIG. 6I is a screen shot of a web page for selecting one of two possible ways to generate data capture tools for quality management, according to an example;

FIG. 6J is a screen shot of a web page for selecting groups of patients based on last visit date for the bulk creation of data capture tools for quality management, according to an example;

FIG. 6K is a screen shot of a web page for selecting groups of patients based on registry membership for the bulk creation of data capture tools for quality management, according to an example;

FIG. 6L is a screen shot of a web page for selecting groups of patients based on provider and last visit date for the bulk creation of data capture tools for quality management, according to an example according to an example;

FIG. 6M is a screen shot of a web page for selecting groups of patients based on registry membership for the bulk creation of data capture tools for quality management, according to an example;

FIG. 6O is intentionally omitted;

FIG. 6N is a screen shot of a web page for selecting groups of patients based on patient name for the creation of data capture tools for quality management, according to an example;

FIG. 6P is a sample of a component used in the dynamic construction of data capture tools for quality management according to an example;

FIG. 6Q is a sample of a fully constructed data capture tool, personalized for an individual patient's specific measure assignments, according to an example;

FIG. 6R is a screen shot of a sample analytical view, according to an example;

FIG. 7 is a screen shot of practice revenues, according to an example;

FIG. 8 is a screen shot of patient visits, according to an example;

FIG. 9 is a screen shot of charges and revenues, according to an example;

FIG. 10 is a screen shot of charges by financial class, according to an example;

FIG. 11 is a screen shot of revenues by financial class, according to an example;

FIG. 12 is a screen shot of collection rates, according to an example;

FIG. 13 is a screen shot of collection rates by payer, according to an example;

FIG. 14 is a screen shot of financial data, according to an example;

FIG. 15 is a screen shot of data shown in FIG. 14 including percent charges of RBRVS, according to an example;

FIG. 16 is a screen shot of data shown in FIG. 15 by payer, according to an example;

FIG. 17 is a screen shot of data shown in FIG. 16 by a selected financial class, according to an example;

FIG. 18 is a screen shot of data shown in FIG. 17 including charges with adjudicated payments, denied charges, and payment lag, according to an example;

FIG. 19 is a screen shot of financial data, according to another example;

FIG. 20 is a screen shot of financial data, according to another example;

FIG. 21 is a screen shot of a number of diabetic patients and a number of visits these patients made to a practice in a given time, according to an example;

FIG. 22 is a screen shot of data shown in FIG. 21 separated by age category, according to an example;

FIG. 23 is a screen shot of data shown in FIG. 22 separated by financial class, according to an example;

FIG. 24 is a screen shot of a number of diabetic patients that also suffer from hypertension, according to an example;

FIG. 25 is a screen shot listing diabetic patients that also suffer from hypertension and the associated number of visits, according to an example;

FIG. 26 is a screen shot listing place of service, according to an example;

FIG. 27 is a screen shot of data shown in FIG. 26 for patients that visited a practice in the last two quarters, according to an example;

FIG. 28 is a screen shot of data shown in FIG. 27 including date of visit, according to an example;

FIG. 29 is a screen shot of data shown in FIG. 28 including primary diagnosis, according to an example;

FIG. 30 is a screen shot of data shown in FIG. 29, including charge to patient, according to an example;

FIG. 31 is a block diagram that shows how a patient registry database may be created and updated, according to an example;

FIG. 32 is a screen shot of a patient registry, according to an example;

FIG. 33 is a physician prompt for diabetes treatment, according to an example;

FIG. 34 is a patient prompt, according to an example; and

FIG. 35 is a physician score report, according to an example.

### DETAILED DESCRIPTION

### Data Extraction and Conversion

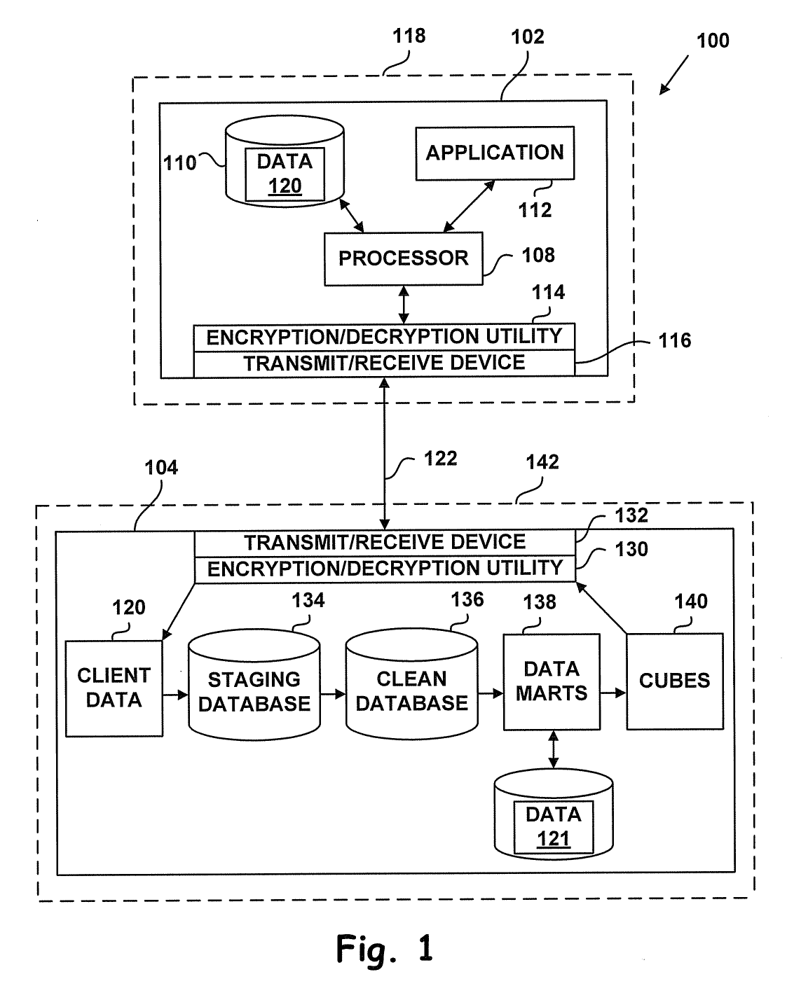

FIG. 1 is a block diagram of a system 100 for data extraction and conversion. The system 100 includes a client server 102 and a database server 104. The system 100 may include additional entities not shown in FIG. 1. Additionally or alternatively, the servers 102,104 may be co-located and/or integrated.

The client server 102 may be a client's source computer system. The client server 102 may include a processor 108, data storage 110, at least one application 112, an encryption/decryption utility 114, and a transmit/receive device 116. The client server 102 may be located behind a client firewall 118. The client server 102 may include additional entities not shown in FIG. 1.

The processor 108 may be a microprocessor suitable for receiving input signals, executing machine language instructions, and providing output signals. The processor 108 may receive input signals internally, such as from the data storage 110. Additionally or alternatively, the processor 108 may receive input signals externally using the encryption/decryption utility 114 and the transmit/receive device 116. The application 112 may include machine language instructions executed by the processor 108. The processor 108 may provide the output signals to entities within the client server 102, such as the data storage 110. Alternatively, the processor may provide the signals to an external entity, such as the database server 104, using the encryption/decryption utility 114 and the transmit/receive device 116.

The data storage 110 may comprise one or more volatile and/or non-volatile storage mechanisms, such as random-access-memory (RAM), flash memory, an optical disk drive, a magnetic disk drive, and so on. Client data 120, in the form of a file or set of files that contain details of client transactions, may be stored in the data storage 110. Additionally or alternatively, some or the entire client data may be stored one or more other servers. For example, the client data 120 may be stored on an external billing, insurance, pharmacy, and/or laboratory system. The client data 120 may be stored in the data storage 110 in a table format. The client data 120 may include customer/patient demographic information and transactional details, such as charges, payments, payment sources, diagnoses, services rendered, service provider, and so on.

The application 112 may be a software program, such as a practice management system, used by the client. The application 112 may facilitate the collection of client data 120 that is stored in the data storage 110. For example, the application 112 may display a form on a computer display that enables a user to enter client data 120 to be stored in the data storage 110. The same or a different application 112 may be used to generate reports for the client. The reports may include some or the entire client data 120 stored in the data storage 110.

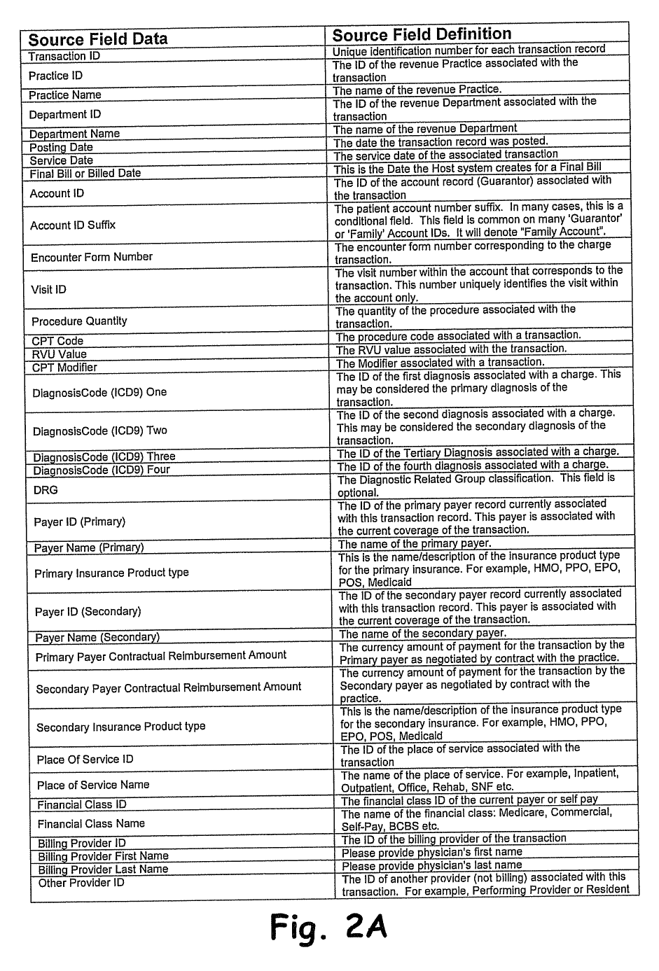

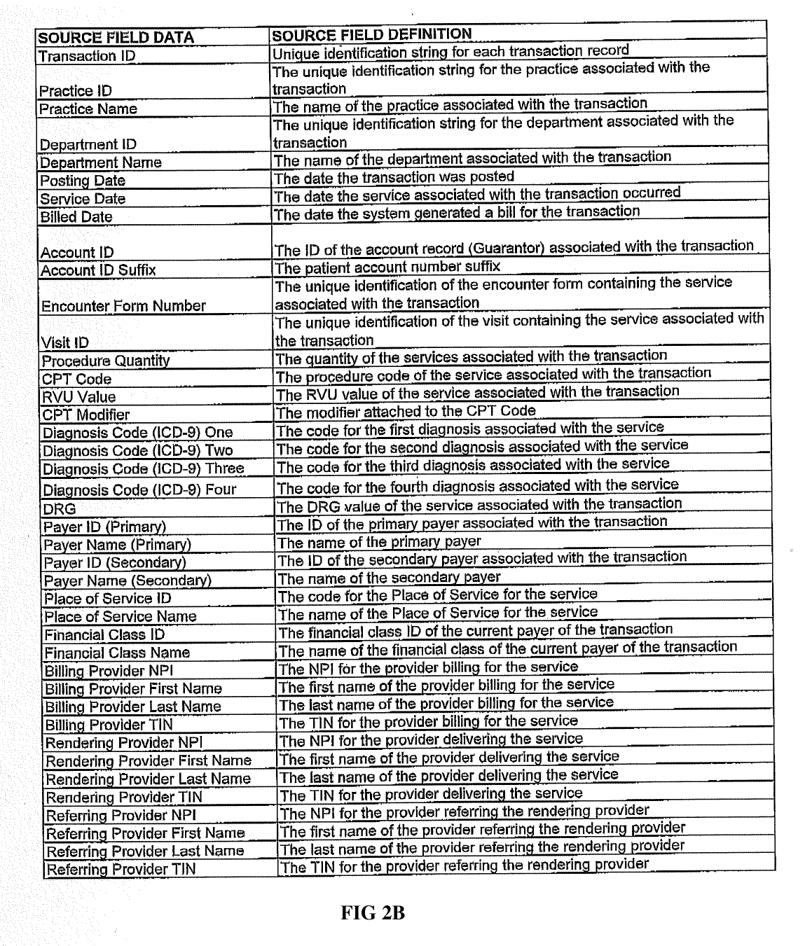

FIGS. 2A-2B is a table of data fields for the client data 120, according to an example. The first column, “Source Field Data,” includes the types of data in a data field, while the second column, “Source Field Description,” includes a definition of the client data associated with the data field. Additional data fields may be included in the table. As seen in the table, the client server 102 may collect client data 120 regarding the practice, the patient, the diagnosis, insurance, and other transactional information regarding a patient's visit to a physician's office.

Referring back to FIG. 1, the encryption/decryption utility 114 may be used to ensure data security for both transmitted and received data. For example, the encryption/decryption utility 114 may be a secure shell (SSH) utility. However, other encryption/decryption methods may be used to allow the client server 102 to securely transmit and receive data over a network, such as a local area network (LAN), a wide area network (WAN), intranet, and the Internet. Alternatively, the client may copy the client data 120 stored on the data storage 110 onto a physical medium, such as a magnetic storage device or an optical storage device, and deliver the physical medium to a user of the database server 104.

The transmit/receive device 116 may allow data to be transmitted and received over a network. For example, the transmit/receive device 116 may be an Ethernet network interface card (NIC). The transmit/receive device 116 may allow the client data 120 to be transmitted and received over network 122. The client firewall 118 may prevent unauthorized entities attached to the network 122 from obtaining the client data 120. The network 122 may provide a communication pathway between the client server 102 and the database server 104. The network 122 may be a LAN, WAN, intranet, or Internet. In another embodiment, the client server 102 and the database server 104 may be co-located and/or integrated and the network 122 may be unnecessary to transfer client data between the client server 102 and the database server 104.

The database server 104 may receive client data 120 from the client server 102 or other external sources using an encryption/decryption utility 130 and a transmit/receive device 132. The encryption/decryption utility 130 may be a SSH utility. However, other encryption/decryption methods may be used to allow the database server 104 to securely transmit and receive data over the network 122. The transmit/receive device 116 may be an Ethernet NIC. The transmit/receive device 132 may allow data to be transmitted and received over the network 122.

The database server 104 may be a computer designed to extract and convert client data 120 that was originally stored on the client server 102 or other system. For example, the database server 104 may receive client data 120 from external billing systems, insurance systems, pharmacy systems, laboratory systems, and other sources. The database server 104 may be running a database program, such as Microsoft SQL Server. Upon receipt of the client data 120, the database server 104 may create a temporary staging database 134. The temporary staging database 134 may be a tabular or relational database that includes some or the entire client data 120.

The contents and details of the client data 120 in the temporary staging database 134 may be quantified and mapped. The contents of the client data 120 may be quantified based on analytic definitions. The analytic definitions are an identification of what questions a practice may ask to further understand their business and clinical operations, and to improve business performance and patient care. For example, the analytic definitions may be performance measures used to gauge a practice. Some of the analytic definitions used by the system 100 are listed below. The analytic definitions are grouped by financially focused analytic definition examples and clinically focused analytic definition examples.

### Financially Focused Analytic Definition Examples

Accounts Receivable (AR) Levels:
Assess if outstanding AR is at a reasonable level
Assess days in outstanding AR (AR level as a function of monthly charges)
   Absolute level of AR vs. monthly charges
   Quantify one-time cash flow savings by having AR at 60 days for insurance payments (payment lag from charge post or billing date)
Determine if the AR trend increasing or declining, By how much

### Collections (Billing Perspective):

Determine the collection rates by financial class and by payer, on charge base and on Resource-Based Relative Value Scale (RBRVS) (RBRVS linked to appropriate schedule for date of service and location of practice)
Determine the denial rates and reasons:
   By Provider
   By Payer
   By Location
   By Current Procedural Terminology (CPT) Code
Determine the total discount, aggregate and by payer
Determine the adjustments and write-offs by reason and by time
Determine the payment lag (days from charge post to payment post)

### Coding:

For primary care, determine if Evaluation and Management (E&M) coding is within expected levels.
   By Provider
   By Practice
What is the revenue opportunity for each CPT code?

Front-End Billing Processes:
Quantify charge lag
   Determine the number of days by place of service
   Determine the number of days by Provider
   Quantify one-time revenue savings by speeding up processes from benchmark
Determine the quality of payer data (see Other Processes below)
Identify the eligibility-related denials
Identify the covered benefits-related denials
Determine issues related to charge capture (comparison of visits vs. billing)
Determine fee schedule quantities (comparison with RBRVS in total and by CPT)

Payer values:
Determine payer mix/reimbursement rate impact
   How overall practice collection rate is driven by collection rates by financial class and, for insurance payers, by individual payers. The end analysis should produce an “ideal” payer mix configuration model for increasing revenues by shifting patient mix into financial classes and payers with higher levels of reimbursement.
Observe varying collection rates, denial rates, and contractual allowances by payer and financial class
   Displays problem payers by first identifying low collection rates based on adjudicated charges (not just posted receipts), and then filters for denial levels/reasons and contractual allowances)
Compare payer reimbursement levels (dollar levels for top CPTs and RBRVS value for top CPTs)

Other Drivers for Practice Revenues:
Determine reimbursement rates per place of service, compared with mix of place of services
   Are services being delivered most productively in settings? (e.g., many services in hospitals and nursing homes—should be stated as $ per place of service-type as well as overall % of visits, charges, and revenues)
Determine visit volumes and reimbursements by physicians and locations
Quantify new visit volumes as % of total visits (by CPT)
Determine service mix (CPTs) and revenues by top CPTs
Quantify patient collections: Copays and days in AR for patients

Other Billing Processes and Data Problems
Observe denial reasons lists (too many/overlapping/not entered)
Observe payer list (duplicate payers/no product type notation/mix of payer guarantors and payers of coverage/missing payers)
Determine place of service listings
Assess patient billing processes (copays, payment at time of visit)

Clinically Focused Analytic Definition Examples
Identify patients for follow-up, and work with practice to effect their return
   With a disease state that requires visits at a regular established frequency (e.g., diabetes)
   As established by a return visit in a given time frame requested by the physician (and recorded in the practice management system).
Identify patients with risk factors for testing or referral, and develop strategy to address
   Age (e.g., >50 years old for colonoscopy)
   Gender (e.g., pap smears, PSA)
   Disease state (e.g., Hgb A1C for diabetics)
   Family history (e.g., abdominal aortic aneurysm for ultrasound of abdomen)
Identify patients with concerning diagnoses or procedures or patients with multiple diagnoses reflecting significant morbidity plus numerous visits
   Perform a chart review where no follow-up is obvious or has not occurred in a timely fashion
   Meet with physician to address contacting these patients
Analyze referrals for consulting physicians and work with physicians to favorably enhance the number and value of referrals
   Determine trends
   Assess importance of different referral sources
   Determine location of referrals (inpatient vs. outpatient) for different referral sources, compare and contrast differences among different referring physicians.
Determine clinical experience from different payer sources
   Calculate numbers of patients with selected diagnoses for individual payers
   For consulting physicians trend selected procedures and diagnoses for individual payers
Determine adherence to series of quality measures (e.g., Hedis) for practices and individual physicians
Determine geographic distribution of patients with different procedures and financial impact
Track patients for lack of completion of ordered laboratory tests and referrals, determine composition of this population for interventional strategies

The content of the data in the temporary staging database 134 may be analyzed to locate sets of information required by the analytic definitions. Typically, a practice management system may store the different types of data separately. For example, the following data types may be stored separately: charges, payments, appointments, aging accounts receivable, and clinical records. The identification of tables and fields need for the analytic definitions may be performed manually or by using a database schema document. Inconsistencies, such as erroneous data types, may be isolated and/or corrected while the client data 120 is in the temporary staging database 134.

The database server 104 may create a clean database 136. The clean database 136 may be created by identifying the relevant sets of data in the temporary staging database 134 and disregarding the non-relevant data sets. The relevant sets of data are then copied to the clean database 136. The clean database 136 may be used to further explore the contents of the client data 120.

Within the clean database 136, queries may be executed to group sets of data together in ways dictated by the analytic definitions. For example, a query may be performed that analyzes the CPT codes found within each transaction and categorizes these transactions by where services were provided. This new categorization may allow the practice to see how many patients have been treated in an office, a hospital, or a nursing home. As another example, a query may be performed that analyzes diagnosis codes and categorizes by diagnosis. This new categorization may allow a practice to see how many diabetic (or any other chronic condition) patients they are treating. Other queries may be performed that locate and correct null values in records, which may have “orphaned” the records.

Once the clean database 136 has been explored, the clean database 136 may be used to separate the data in the clean database 136 into smaller, related groups of data, herein referred to as datamarts 138. The datamarts 138 may be created by separating the client data 120 according to requirements of the analytic definitions. For example, one datamart 138 may include financial information, while another datamart 138 may include scheduling information. By separating the client data 120 into datamarts 138, the datamarts 138 may be queried to provide concise, meaningful analyses to a client. These analyses may be performed using a standard set of data.

However, customized analysis may be performed using a client's unique data or needs. For example, the datamarts 138 may include information relevant to revenue cycles, the flow of customers/patients of specific interest, and/or any other analysis desired by the client.

The Master Patient Registry (MPR) database 121 may be created using datamarts 138. The MPR database 121 may utilize elements of claims data that have clinical value, such as patient demographic information (e.g., gender, age, ZIP code, etc), diagnoses (e.g., in the form of ICD-9 codes), and procedures (e.g., in the form of CPT codes). The MPR database 121 may be created by analyzing each record in the datamarts 138 for combinations of data that match rules defined for Clinical Quality Measures which are stored in the Systems Management Database 432. When the data in a record within a datamart 138 matches the criteria defined in a Measure, the patient and service provider associated with that record is assigned to that Measure as a record in the MPR database 121. Each Measure has Quality Codes associated with it, and the MPR database 121 may receive data indicating the presence of a Quality Code from the datamarts 138 or from the web application 422 defined in system 400.

The datamarts 138 may be processed into multidimensional databases called cubes 140. The datamarts 138 may be processed into cubes 140 using an on-line analytical processing (OLAP) engine, such as Microsoft Analysis Services. OLAP engines may perform multidimensional expression (MDX) analysis of data, including complex calculations, trend analysis, and modeling. Those skilled in the art are familiar with the operation of OLAP engines.

The cubes 140 may be constructed to provide adequate capacity to analyze financial trends of the practice, payer contract assessment, patient volume and trends, physician-specific activity, clinical volume and trends, and patient population tracking and trends. These cube areas are listed below.

1. Financial Cube: Financial Trends of the Practice
a. Analysis of financial activity by dates of service and posting dates
b. Aged accounts receivable
c. Charge posting lag
d. Payment lag from date of billing
e. Payer mix and by-payer reimbursements
f. Collection rates, contractual allowances, and denied charges
g. Denial reasons
h. RBRVS-benchmarked collections and payments
i. Procedure coding
j. Other drivers for practice revenues: place of service efficiencies, service mix by CPT, lab reimbursements and costs

2. Payer Cube: Payer Contract Assessment
a. Patient mix by payer
b. By-payer collection results (charge-based and RBRVS), denials, payment lags, and total discount
c. Payment variability between payer fee schedule and payment level

3. Patient Cube: Patient Volume and Trends
a. Zip code and demographic trends
b. New visit growth trends
c. Patient age groupings

4. Physician Cube: Physician-Specific Activity
a. Activities sorted by physician, location, CPT and CPT groupings
b. By-physician and by-location charges, revenues, procedure coding
c. Office appointment through-put by location and physician

5. Clinical Cube: Clinical Volume and Trends
a. E & M coding and procedural activity
b. Patient listings for diagnoses of concern
c. Referral source trends by type of cases and aggregated severity

6. Electronic Medical Records (EMR) Cube: Patient Population Tracking and Trends
a. Medication filters, including grouped indicators by class (e.g. Angiotensin-Converting Enzyme (ACE) inhibitors)
b. Blood pressure trending and variation, by physician and by person-performing
c. Lipid result trending and variations by location, physician, and medication or combination of medications
d. Filters or trends for other laboratory results, e.g. C-reactive protein or other inflammatory markers
e. Use of aggregate CPTs to assess groups of patients with particular procedures to time-trend other complications or interventions
f. Use of genetic and patient history information to track outcomes related to disease.
   Not all clients will need to generate all the cubes 140 identified above. However, additional cubes 140 may also be generated.

Once the cubes 140 are generated, the cubes 140 may be stored. The cubes 140 may be stored on the database server 104. Alternatively, the cubes 140 may be stored at an offsite datacenter. In the datacenter embodiment, the cubes 140 may be transmitted to the client server 102 or another server via a network, such as network 122. The cubes 140 may be transferred using an encryption/decryption utility, such as SSH. Alternatively, the cubes 140 may be transferred to a datacenter by copying the cubes 140 onto a physical medium, such as a magnetic storage device or an optical storage device, and delivering the physical medium to the datacenter.

The database server 104 may be located behind a service firewall 142. The service firewall 142 may prevent unauthorized entities attached to the network 122 from obtaining the client data 120, patient registry data 121, and/or converted data.

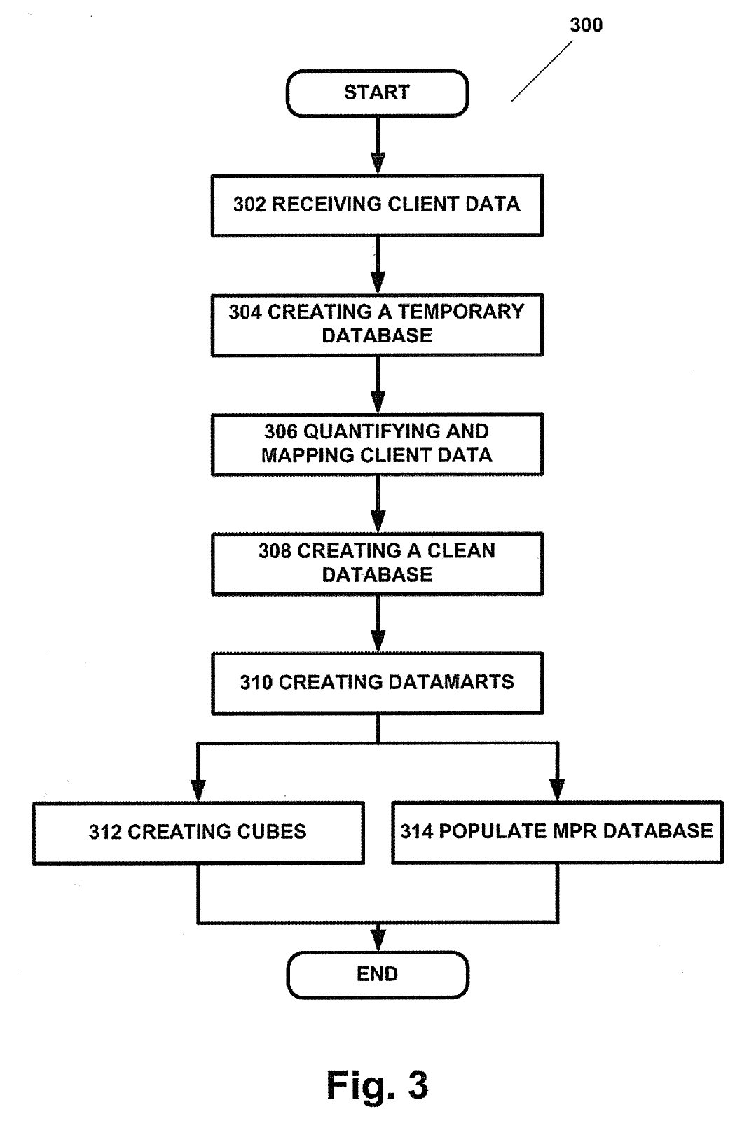

FIG. 3 is a flowchart of a method 300 for data extraction and conversion, according to an example. The method 300 is explained with reference to the system 100 depicted in FIG. 1. The method 300 may also include additional steps not depicted in FIG. 3.

At block 302, client data 120 may be received by the database server 104. The client data 120 may be in the form of a table. For example, the client data 120 may include the types of data depicted in FIGS. 2A-2B.

At block 204, a temporary staging database may be created. The temporary staging database 134 may be a tabular or relational database that includes some or the entire client data 120.

At block 306, client data 120 may be quantified and mapped. The contents of the client data 120 may be quantified based on analytic definitions. The analytic definitions are an identification of what questions a practice may ask to further understand their business and clinical operations, and to improve business performance and patient care. The content of the data in the temporary staging database 134 may be analyzed to locate sets of information required by the analytic definitions. The identification of tables and fields need for the analytic definitions may be performed manually or by using a database schema document. Inconsistencies, such as erroneous data types, may also be isolated and/or corrected while the client data 120 is in the temporary staging database 134.

At block 308, a clean database 136 may be created. The clean database 136 may be created by identifying the relevant sets of data in the temporary staging database 134 and disregarding the non-relevant data sets. The relevant sets of data are then copied to the clean database 136. The clean database 136 may be used to further explore the contents of the client data 120.

At block 310, datamarts 138 may be created. The datamarts 138 may be created by separating data in the clean database 136 according to requirements of the analytic definitions. By separating the client data 120 into datamarts 138, the datamarts 138 may be queried to provide concise, meaningful analyses to a client. For example, the datamarts 138 may include information relevant to revenue cycles, the flow of customers/patients of specific interest, or any other analysis desired by the client.

At block 312, cubes 140 may be created. The datamarts 138 may be processed into cubes 140 using an OLAP engine. The cubes 140 may be constructed to provide adequate capacity to analyze financial trends of the practice, payer contract assessment, patient volume and trends, physician-specific activity, clinical volume and trends, and patient population tracking and trends.

At block 314, the MPR database 121 may be created by analyzing each record in the datamarts 138 for combinations of data that match rules defined for Clinical Quality Measures which are stored in the Systems Management Database 432. When the data in a record within a datamart 138 matches the criteria defined in a Measure, the patient and service provider associated with that record is assigned to that Measure as a record in the MPR database 121

### Creation and Utilization of a Master Patient Registry (MPR) Database

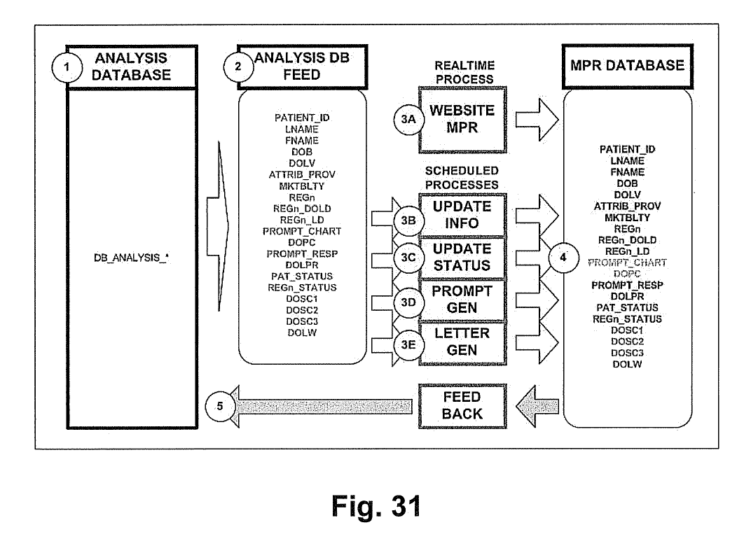

FIG. 31 is a block diagram that shows how a patient registry database may be created and updated. At block 1, the analysis database is primarily sourced from claims data and is later supplemented with additional data generated as described below. The analysis database may contain elements of claims data that have clinical value, such as patient demographic information (e.g., gender, age, ZIP code, etc), diagnoses (e.g., in the form of ICD-9 codes), and procedures (e.g., in the form of CPT codes). The analysis database may use this information to develop a series of registries that correspond to patient populations under clinical quality review, based on diagnosis or procedure history or other factors such as age and gender. The individual registries may overlap, but the MPR database may show unique patients with multiple registries listed. Several methods can be used to attribute a provider to the patient and his/her registries. These registries can be further stratified through the import of additional data gathered outside the claims process as described as follows.

At process 2, a query from the analysis database (i.e., Analysis Database Feed) of patient information as it pertains to a patient's inclusion in condition registries may be performed. The information gathered here may include patient identification, last known participation status, last known status of all condition registries, date and nature of the last known registry trigger, last known date of service with that practice, and last known prompt responses. If any of the above information is not yet resident in the analysis database, default or null values may be used. This query is triggered by an update of claims data in the analysis database.

After the query from the analysis database, a variety of collection of processes imports and updates all information into the MPR database, including both real-time and scheduled processes. Five collection processes may be used to update the MPR database as described with reference to process 3A-3E.

At process 3A, an MPR Website is used by an authorized physician or their agent to log into the MPR database and update certain patient status information. The user can see and alter the status of the patient in the practice. For example, if a patient has died, moved away or has been dismissed, the user can select a checkbox to indicate that updated status. Similarly, the user can view all of the condition registries that the patient fits into and review that information. The user may then select a checkbox if he/she feels that the patient has been erroneously included in that registry or if that particular condition is not being handled in the practice. Changes performed through the web interface may be immediately applied directly to the MPR database, and the MPR database may internally log when these changes occurred.

At process 3B, the MPR database may run a scheduled process to ensure that a patient's membership in the practice is up to date. The Update Information process retrieves information on the patient from the Analysis Database Feed, such as last known date of service, last known place of service, last known attributed provider, and other elements. The MPR database uses information pertaining to the last known visit to determine if the patient is still considered active in the practice. If the last known date of service is over twenty-four months earlier than the present date, then the MPR database may flag that patient as inactive. The MPR database may run this process on a periodic basis, such as once a day.

Similar to process 3B, at process 3C, the MPR may run a scheduled process to ensure that a patient's inclusion or exclusion in a condition registry is confirmed by the most recent claims data. The Update Status process retrieves information on the patients from the Analysis Database Feed such as the dates and nature of the last known registry triggers. For example, if a patient has been considered erroneously included in a registry and recorded as such using the MPR web interface, the Update Status process searches for confirming information.

If the trigger information in the Analysis Database Feed is older than the exclusion information in the MPR database, then the patient's status in that registry remains unchanged. However, if the Analysis Database Feed has information that again triggers a patient's membership in a registry, and is newer than the exclusion information in the MPR database, then the patient's status in that registry is updated in the MPR database. The MPR database may run this process on a periodic basis, such as once a day.

A physician prompt is the physical representation of a set of questions to be answered by the provider at the point of care, usually a paper from positioned in the patient's medical record. The physician prompt codes and uses are addressed later in detail. For the purposes of the MPR database, the physician checks the applicable answers on the prompt form and these codes are then entered into the practice management system as procedure codes and modifiers to be ultimately collected by the analysis database.

At process 3D, the MPR database runs a scheduled process to generate a prompt if a patient is eligible to receive one. The Prompt Generation process checks the Analysis Database Feed for a patient's status in a condition registry and whether that patient had received a prompt already. If a patient is in a registry and has not received a prompt for that condition (if a prompt exists for that condition), then the Prompt Generation process may create a prompt specifically for that patient given their specific combination of conditions. The MPR database maintains a set of components that may be assembled dynamically for each patient when they become eligible for a prompt. That prompt can then be printed out and filed in the patient's medical record. The MPR database may run this process on a periodic basis, such as once a day.

A patient communication letter may be generated by the MPR encouraging a course of action for the patient to take, for certain clinical conditions and agreements with some physicians. The letters are designed to appear as if they were generated by the practice, and bear the signatures of that practice's physicians.

At process 3E, the MPR database runs a scheduled process to generate a letter if a patient is eligible to receive one. The Letter Generation process checks the Analysis Database Feed for the date of the most recent sent communication, if any. If a patient has not received a certain communication or letter and is eligible to receive one, then the Letter Generation process may create a letter specifically for that patient given their specific role in the practice's overall communication strategy. The MPR database maintains a set of components that may be assembled dynamically for each patient when they become eligible for a letter. That letter can then be printed out and mailed to the address on file. The MPR database may run this process on a periodic basis, such as once a day.

When processes 3A-3E generate new information, the new information may be supplied to the MPR database at process 4. At process 5, the analysis database synchronizes itself with the latest information contained in the MPR database. Information that was updated via the web interface as well as tracking information regarding generated prompts and letters are sent back to the analysis database to enable reporting on claims data supplemented with quality and process information.

### Accessing Analytical Data

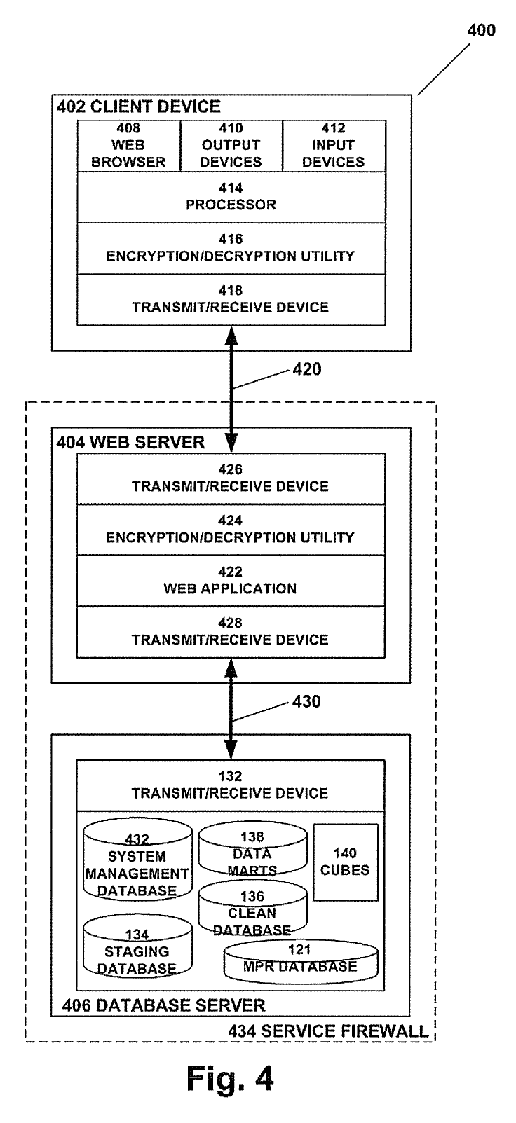

FIG. 4 is a block diagram of a system 400 for client access to analytical data, according to an example. The system 400 includes a client device 402, a web server 404, and a database server 406. The system 400 may include additional entities not shown in FIG. 4. Additionally or alternatively, the servers 404, 406 may be co-located and/or integrated.

The client device 402 may be a computing device or a terminal connected to a computing device. The client device 402 includes a web browser 408, output devices 410, input devices 412, a processor 414, an encryption/decryption utility 416, and a transmit/receive device 418. The client device 402 may include additional entities not depicted in FIG. 4. The client device 402 may allow a user of the client device 402 to remotely access analytical data.

The web browser 408 may be an application that allows web pages to be viewed by the user of the client device 402. The web browser 408 may fetch a web page that is requested by the user, interpret the text, format commands within the text, and then properly display the web page on a screen. For example, the web browser may be Mozilla Firefox or Microsoft Internet Explorer. Those skilled in the art are familiar with the operation of web browsers.

The processor 414 may be a microprocessor suitable for receiving input signals, executing machine language instructions, and providing output signals. The processor 414 may receive inputs from entities within the client device 402 or from external sources via the input devices 412. The input devices 412 may include any device that provides inputs to the client device 402, such as a keyboard, microphone, or mouse. The processor 414 may be operable to execute commands from the web browser 408 and/or other applications on the client device 402. The processor 414 may provide outputs to entities within the client device 402 or to external sources using the output devices 410. The output devices 410 may be any device that provides an output to a user of the client device, such as a monitor or printer.

The encryption/decryption utility 416 may be used to ensure data security for both transmitted and received data. For example, the encryption/decryption utility 416 may be a SSH utility. However, other encryption/decryption methods may be used to allow the client device 402 to securely transmit and receive data over a network, such as a LAN, a WAN, intranet, and the Internet.

The transmit/receive device 418 may allow data to be transmitted and received over a network. For example, the transmit/receive device 418 may be an Ethernet NIC. The transmit/receive device 418 may allow a user of the client device 402 to request and receive analytical data. A network 420 may provide a communication pathway between the client device 402 and the web server 404. The network 420 may be a LAN, WAN, intranet, or Internet.

The web server 404 may be a computer connected to an intranet or the Internet that stores and displays documents and files. The web server 404 may include a web application 422, an encryption/decryption utility 424, a first transmit/receive device 426, and a second transmit/receive device 428. The web server 404 may include additional entities not depicted in FIG. 4.

The web application 422 may be a software application that is operable to select and display appropriate web pages on the client device 402. The web application 422 may receive a request from the web browser 408 for a web page. The web application 422 may respond to the request by verifying the user's authorization to have access to the web page, and if authorized, providing the requested web page to the web browser 408. The web application 422 may receive the request for a web page and respond to the request using the encryption/decryption utility 424 and the first transmit/receive device 426.

The encryption/decryption utility 424 may be used to ensure data security for both transmitted and received data. For example, the encryption/decryption utility 424 may be a SSH utility. However, other encryption/decryption methods may be used to allow the web server 404 to securely transmit and receive data over the network 420.

The first transmit/receive device 426 may allow data to be transmitted and received over the network 420. The second transmit/receive device 428 may allow data to be transmitted and received over a network 430. For example, the first transmit/receive device 426 and the second transmit/receive device 428 may each be an Ethernet NIC.

The network 430 may provide a communication pathway between the web server 404 and the database server 406. In a preferred embodiment, the network 430 is a LAN; however, the network 430 may be a WAN, intranet, or Internet. In another embodiment, the web server 404 and the database server 406 may be co-located and/or integrated and the network 430 may be unnecessary.

The database server 406 may be substantially the same as the database server 104 depicted in FIG. 1. In addition to the entities depicted in FIG. 1, the database server 406 includes a system management database 432. The system management database 432 may include client authorization data and Quality Measure and Registry definition information. The client authorization data may include a database record associated with each authorized user that indicates which menus (lists and categories of views attributed to the specific user), views (OLAP queries, specifically MDX queries, already written and attributed to the user), databases, and overall content is available to the user with those credentials. The Measure and Registry definition information may include the combinations of data required to assign a patient to a Measure or Registry. Additionally, the database record may include a query code associated with each client that specifies an initial web page to be displayed to the client upon successful credential verification or other user specific permissions. Upon login to the database, the user may see patients that are displayed automatically into groups (Measures and Registries) based on a combination of diagnoses, clinical procedures, demographics and other factors, through the analysis of data within this system.

The web server 404 and the database server 406 may be located behind a service firewall 434. The service firewall 434 may prevent unauthorized entities attached to the network 420 from obtaining the analytical data.

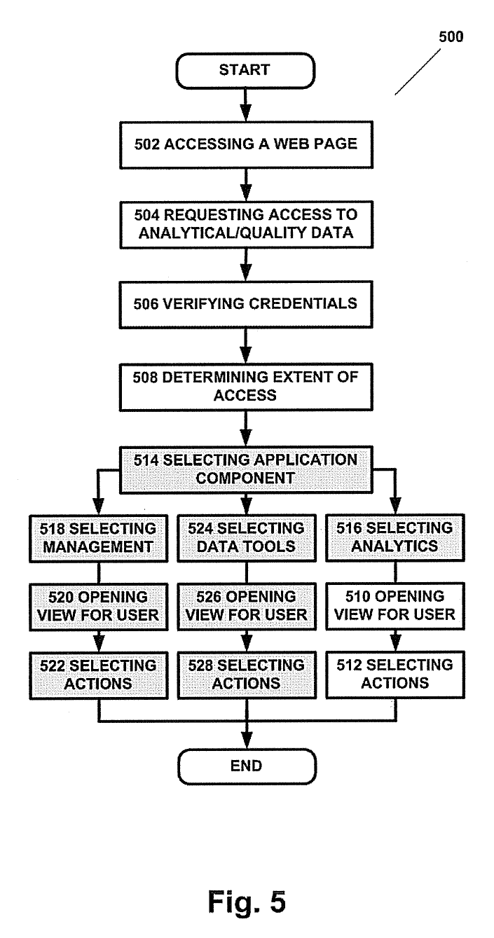

FIG. 5 is a flow chart of a method 500 of accessing analytical data using the system depicted in FIG. 4, according to an example. The method 500 is explained with reference to the system 400 depicted in FIG. 4. The method 500 may also include additional steps not depicted in FIG. 5.

At block 502, the user may access a web page. The user may use a universal resource locator (URL) to access the web page. The web page may be associated with the database server 406. The web server 404 may transmit the proper web page to the user. The user may click on publicly available links on the web page and the web server 404 may produce the selected pages to be displayed on the client device 402.

At block 504, the user may request access to analytical data. The user may click on a link to logon into the web application 422. The web server 404 may transmit a page containing a logon form. This transmission may be encrypted by the web server 404 and decrypted by the web browser 408 on the client device 402. The user may enter authorized logon credentials into the logon form and submit the form. This transmission may be encrypted by the web browser 408 on the client device 402 and decrypted by the web server 404.

At block 506, the web server 404 may verify the user's credentials. The web server 404 may access the system management database 432 and compare the user's credentials with the system management database 432. If the user's credentials do not match those in the system management database 432, the web server 404 may re-transmit the logon form with an appropriate error message so the user may try again.

At block 508, the web server 404 may determine the extent of the user's access to the analytical data. If the user's credentials match those of a record within the system management database 432, the web server 404 may determine what content the user has access to by reading from the database record associated with the user. The database record associated with the user may dictate which menus (lists and categories of views attributed to the specific user), views (OLAP queries, specifically MDX queries, already written and attributed to the user), databases, and overall content is available to the user with those credentials.

At block 514, the web server 404 may display a web page with several links to components of the web application 422, depending on the records within the system management database 432. The web server 404 may display links for, but not limited to, Quality Management, Data Capture Tools, and Analytical Tools.

At block 518, the user may move the mouse cursor to a hyperlink for a component of web application 422 that manages Quality Measures and Registries, and click upon it.

At block 520, the web server 404 opens the appropriate web page for the user. The web server 404 may select from the system management database 432 the proper patients, measures and registries to generate the web page as seen by the user. The web server 404 queries the MPR database 121 on the database server 406 with the information received from the system management server 432. The database server 406 (or the offsite datacenter) may transmit the query results to the web server 404. The web server 404 may send to the user's browser 408 a dynamically built web page containing the practices, providers, measures, registries and patients specifically assigned to that user. This transmission may be encrypted by the web server 404 and decrypted by the user's browser 408 on the client device 402.

At block 522, the user may perform several actions within the web application 422 at this point. For example, the user may:
a. Select a Practice from a drop-down box to repopulate the web page with data originating from a different practice.
b. Select a Provider from a drop-down box to repopulate the web page with data originating from a different provider.
c. Sort Measures by Category, Measure Name, the Patient Count, or the Completion percentage.
d. View Measure-wide results and click on a Measure to view the results of individual patients.
e. Sort the Patients by Response Status, Patient Name, Eligibility Criteria, Effective

Date, or Response Code.
f. Open the help page.
g. Return to the previous web page.
h. Logout.
i. Exit the application. The user may terminate the browser session by closing the application window.
   The user may perform additional actions as well.

At block 524, the user may move the mouse cursor to a hyperlink for a component of web application 422 that manages Quality Code Data Capture Tools, and click upon it.

At block 526, the web server 404 opens the appropriate web page for the user. The web server 404 may select from the system management database 432 the proper patients, measures and registries to generate the web page as seen by the user. The web server 404 queries the MPR database 121 on the database server 406 with the information received from the system management server 432. The database server 406 (or the offsite datacenter) may transmit the query results to the web server 404. The web server 404 may send to the user's browser 408 a dynamically built web page containing the practices, providers, measures, registries and patients specifically assigned to that user. This transmission may be encrypted by the web server 404 and decrypted by the user's browser 408 on the client device 402.

At block 528, the user may perform several actions within the web application 422 at this point. For example, the user may:
a. Click on a hyperlink that begins the data capture tool generation process by broad categories of patients.
b. Click on a hyperlink that begins the data capture tool generation process by individual patients.
c. Open the help page.
d. Return to the previous web page.
e. Logout.
f. Exit the application. The user may terminate the browser session by closing the application window.
   The user may perform additional actions as well.

At block 516, the user may move the mouse cursor to a hyperlink for a component of web application 422 that manages Analytical Tools, and click upon it.

At block 510, the web server 404 opens the appropriate view for the user. The web server 404 may select from the system management database 432 the query code that queries the proper cube 140 to generate the opening view as seen by the user. The web server 404 queries the cube 140 on the database server 406 with the query code. The database server 406 (or the offsite datacenter) may transmit the query results to the web server 404. The web server 404 may send to the user's browser 408 a dynamically built web page containing the dropdown menus and initial/opening view specifically assigned to that user as well as a list of fields illustrating the contents of the cube being used by that view. This transmission may be encrypted by the web server 404 and decrypted by the user's browser 408 on the client device 402.

At block 512, the user may perform several actions within the web application 422 at this point. For example, the user may:
a. Select and open another pre-written view from the user menu. The user may move the mouse cursor to the menu categories and a predefined list of views may descend. The user may then click on the view title and the method 400 may be repeated except that the web page displayed on the user's client device may be based on the query associated with the view selected.
b. Regenerate the current pre-written view. The user may move the mouse cursor to the “Restore” button and click on the Restore button to have the currently selected view regenerate to a default configuration.
c. Display the query code that was used by the system to generate the view. The user may move the mouse cursor to the “MDX” button and click on the MDX button to have the query code for the current view configuration appear in a separate application window.
d. Send the contents of the view to ExcelView. The user may move the mouse cursor to the “Excel” button and click on the Excel button to have the contents of the current view configuration export into a web-based version of Microsoft Excel, where all the functions of that product may be utilized.
e. Hide or unhide the Field List. The user may move the mouse cursor to the “Fields” button and click on the Fields button to hide or unhide the Field List.
f. Modify the current view using Measures and Dimensions from the Field List. The user may click on a folder in the Field List and add new Dimensions (fields) or Measures to the view in a “drag and drop” manner. In this process, the web application 422 may dynamically create a new MDX query that is run against the cube 140. The method 500 may be repeated except that the view that appears is based upon the results of the newly altered MDX query.
g. Save a modified view for later use. The user may move the mouse cursor into the menu bar on the “My Views” heading and add the current view to the user menu by clicking “Add View.” This process may add the MDX query code for the current view into the system management database 332 to be incorporated into the user's view menu.
h. Exit the application. The user may terminate the browser session by closing the application window.
   The user may perform additional actions as well.

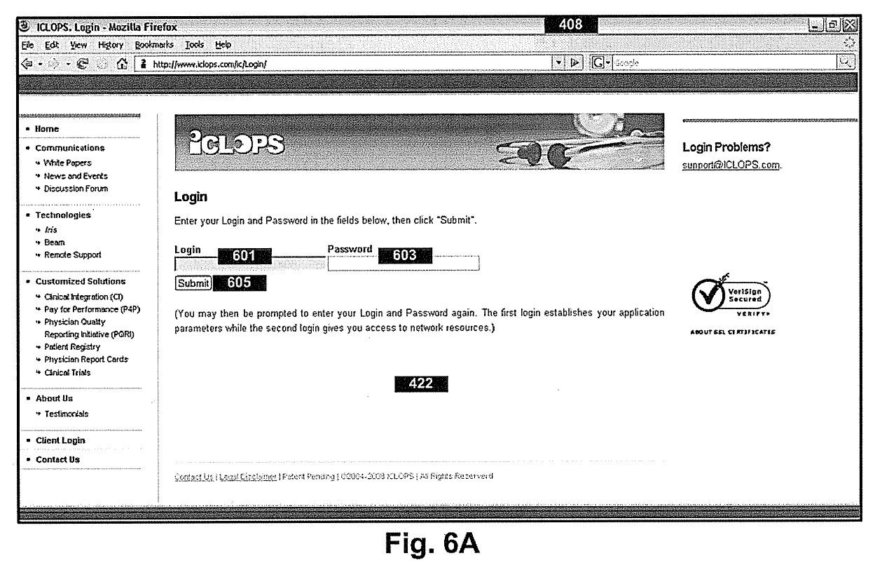

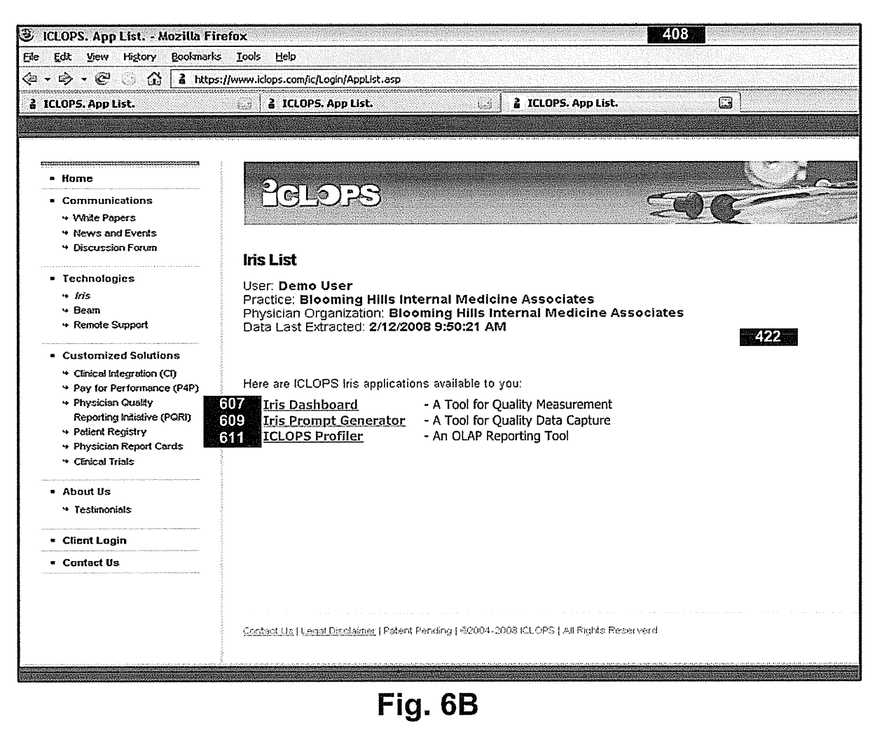

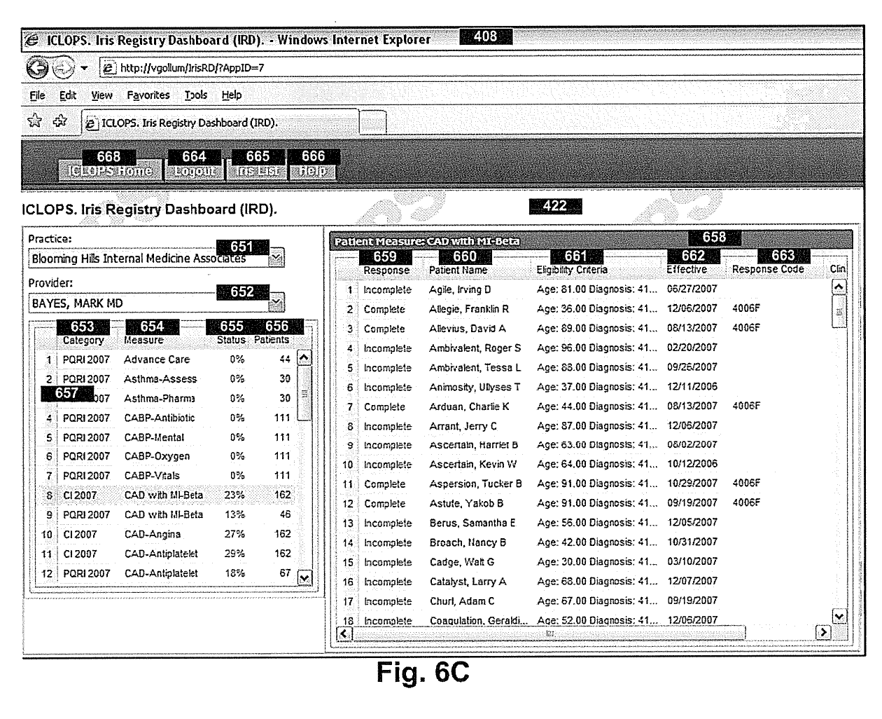

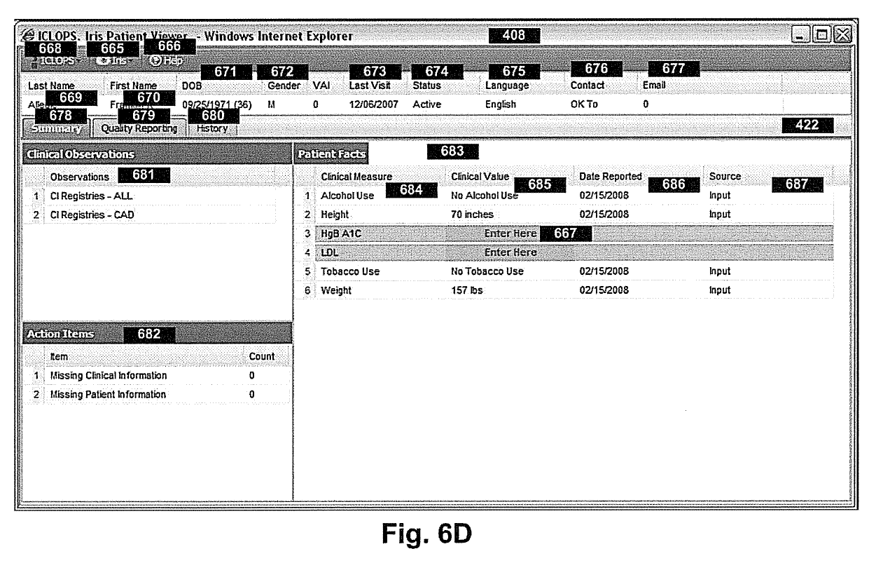

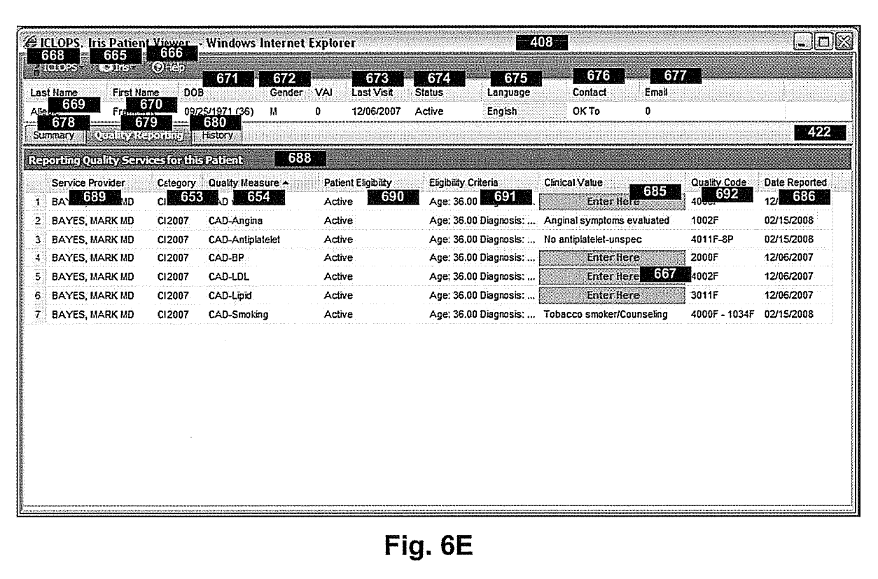

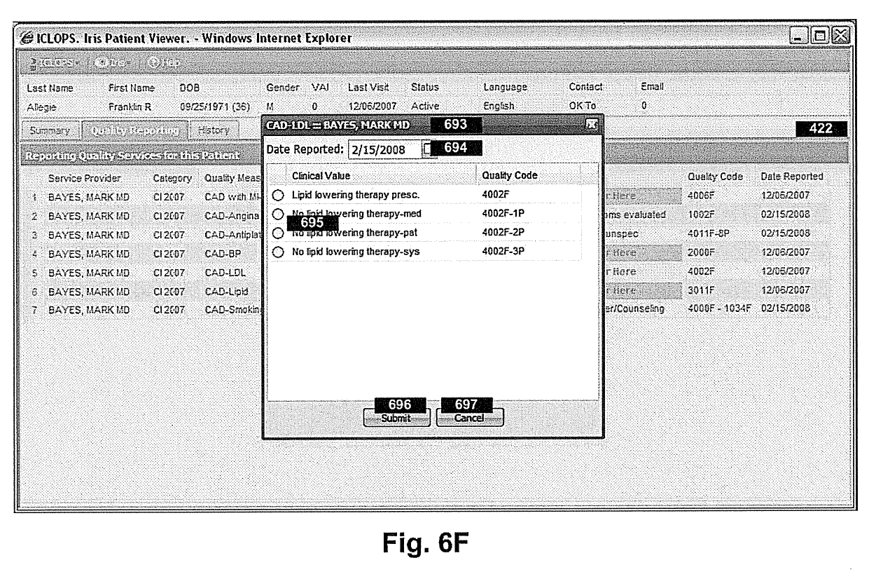

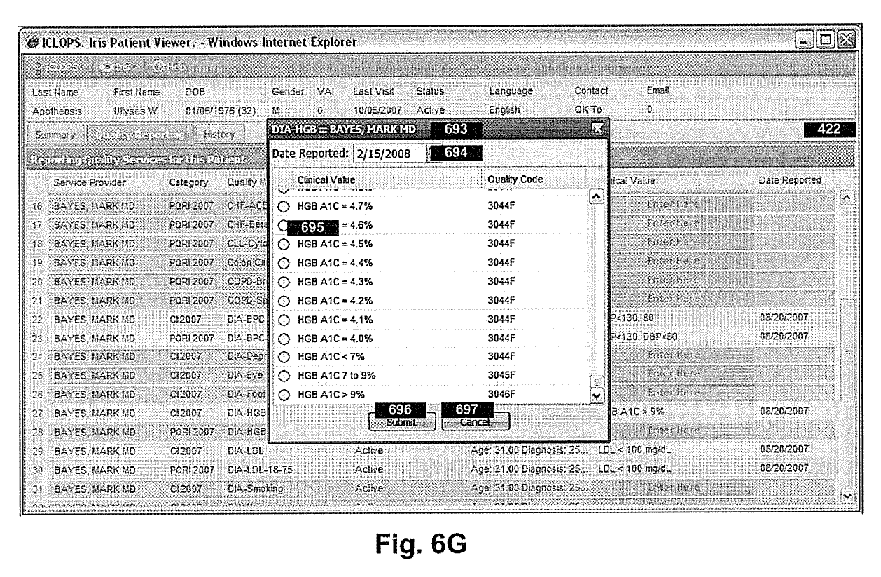

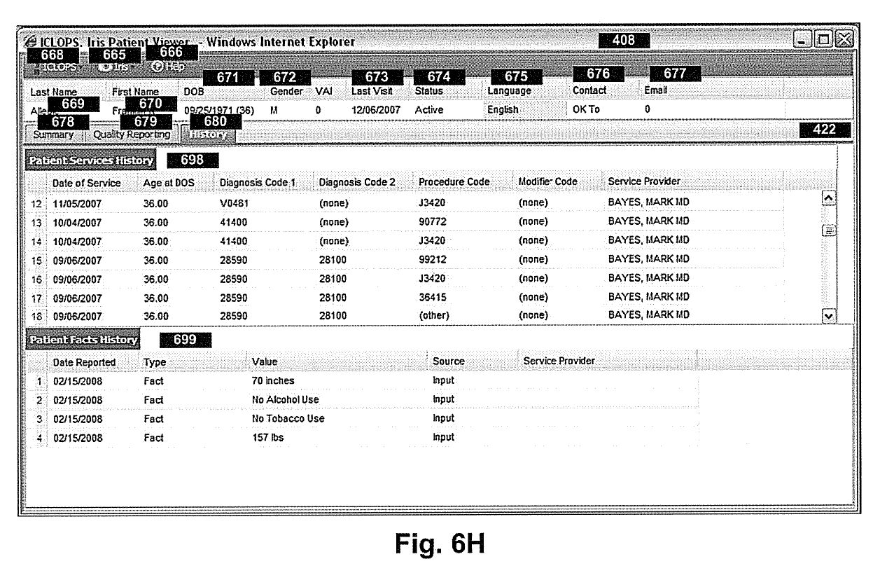

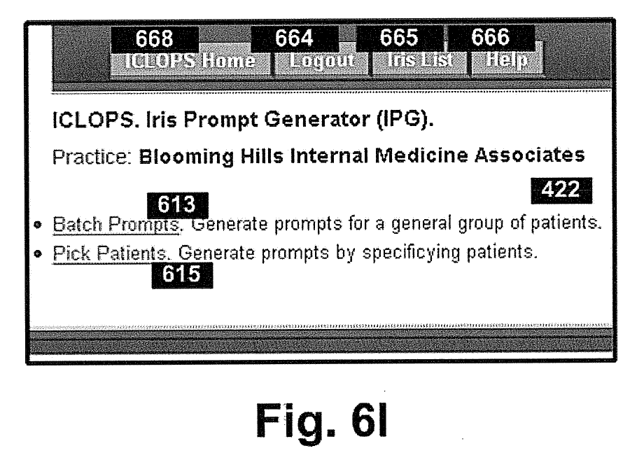

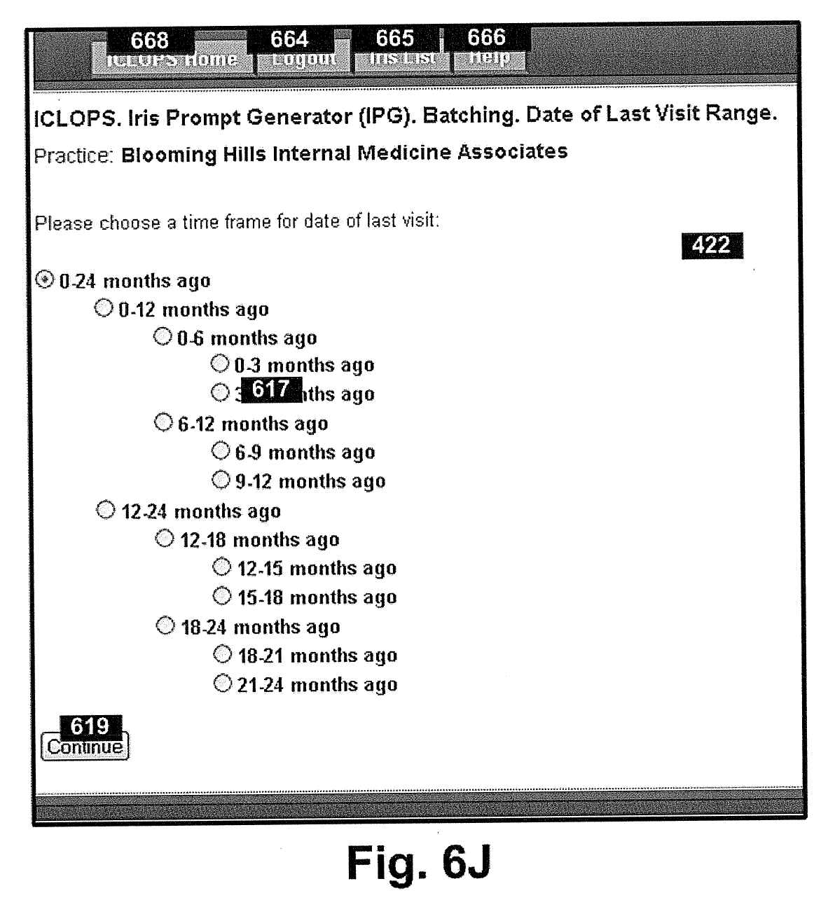

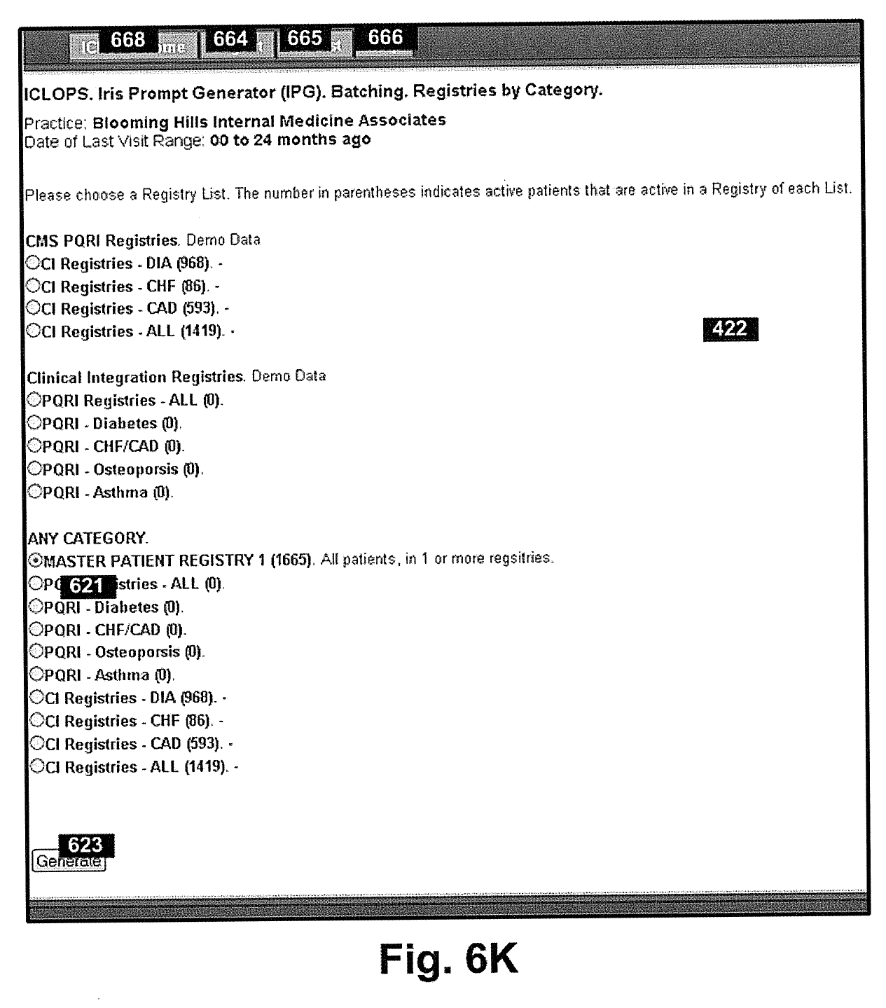

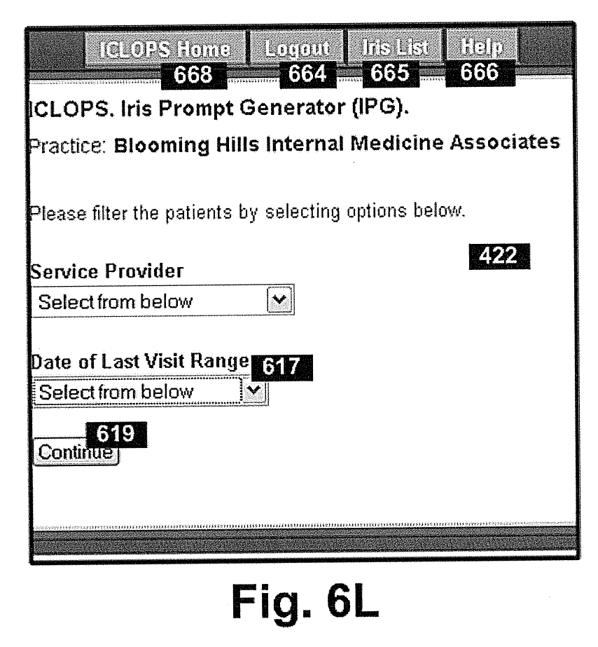

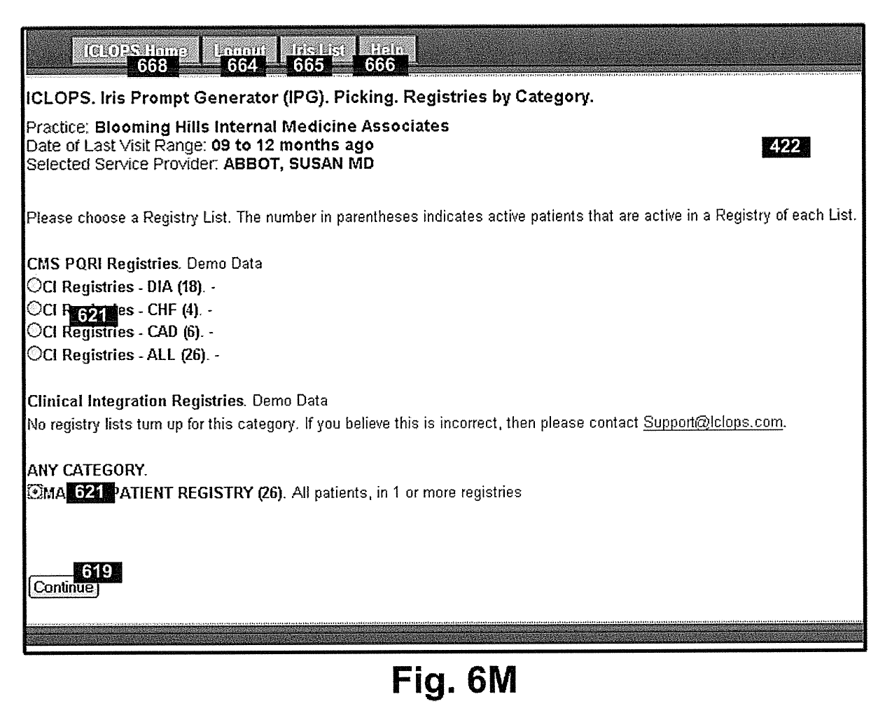

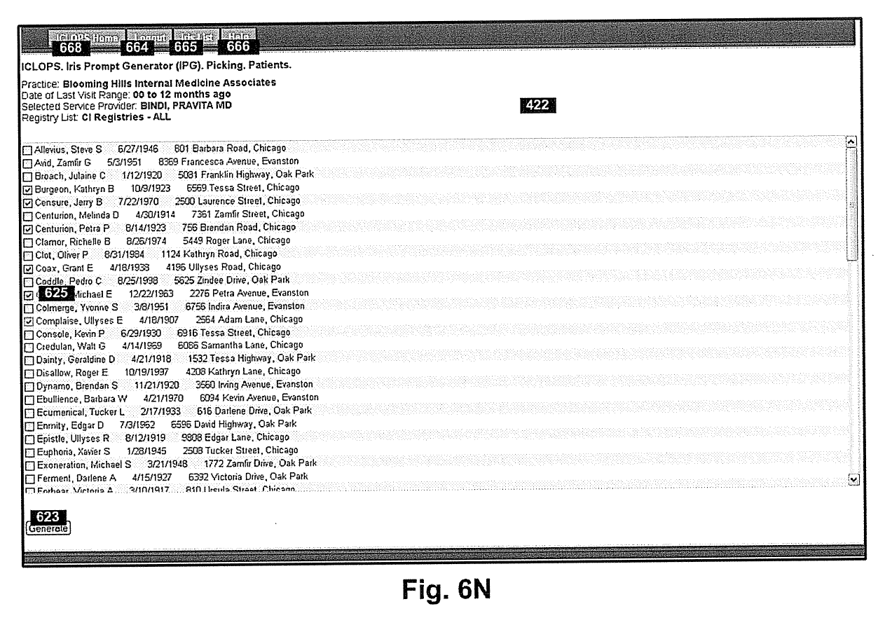

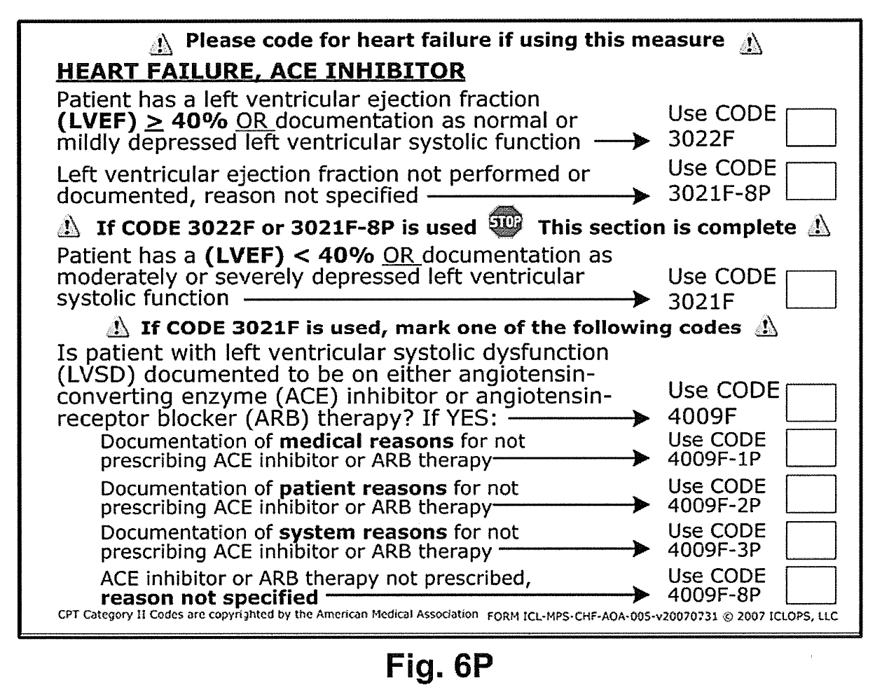

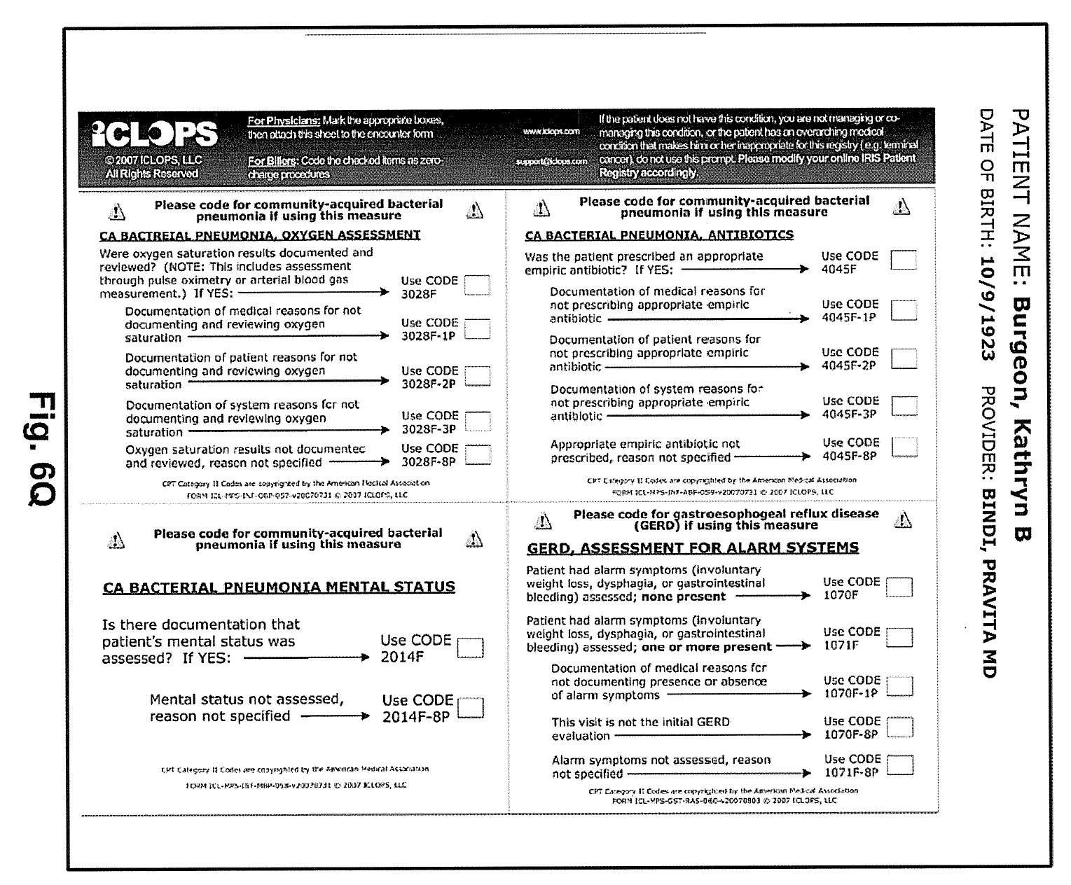

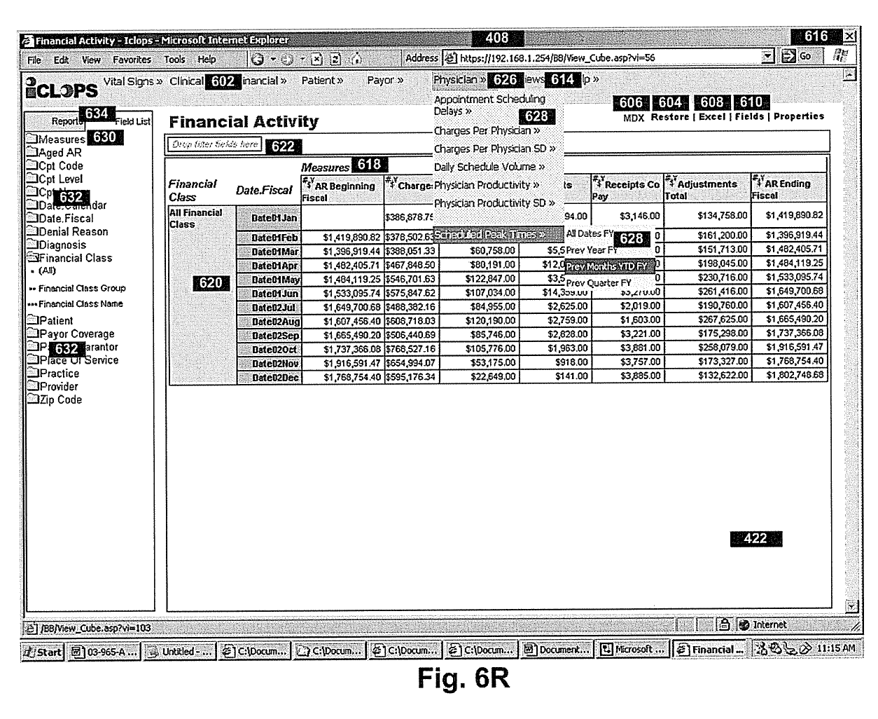

FIG. 6A is a screen shot of a web page for entering user credentials, according to an example. This view may be used to explain how the user may perform the actions listed above with reference to block 506 within the web application 422.

The user may enter a user name by typing it in the Login Entry Space 601. The user name is a part of the identification information used by the systems management database 432 in the determination of access. The user may enter a password by typing it in the Password Entry Space 603. The password is a part of the identification information used by the systems management database 432 in the determination of access.

After having input a user name and a password in the locations described above, the user may submit these credentials to the systems management database 432 by clicking on the Submit Button 605. If successful, the web application 422 will transmit a different web page to the web browser 408. If not successful, the web application 422 will display an error message. The user may exit the application by clicking on the Exit button 616 to close the application window.

FIG. 6B is a screen shot of a web page for selecting an application component, according to an example. This view may be used to explain how the user may perform the actions listed above with reference to blocks 514, 516, 518 and 524 within the web application 422. The user may move the mouse cursor to a hyperlink 607 for a component of web application 422 that manages Quality Measures and Registries, and click upon it.

The user may move the mouse cursor to a hyperlink 609 for a component of web application 422 that manages Quality Code Data Capture Tools, and click upon it. The user may move the mouse cursor to a hyperlink 611 for a component of web application 422 that manages Analytics, and click upon it. The user may exit the application by clicking on the Exit button 616 to close the application window.

FIG. 6C is a screen shot of a web page for reviewing the status of all patients assigned to all measures for a physician, according to an example. When this web page is displayed, the user will see all Quality Measures that reflect the national consensus standards for patient care for the user's clinical specialty. Using this web page, the user may identify the status of compliance with accepted standards of quality for each clinical service, as reflected by the data in the database.

This view may be used to explain how the user may perform the actions listed above with reference to blocks 520 and 522 within the web application 422.

The user may select a practice from a drop-down box 651 to repopulate the web page with data originating from a different practice. The user may select a provider from a drop-down box 652 to repopulate the web page with data originating from a different provider. In this manner, results on quality standards are displayed distinctly each provider in the organization.

The user may sort measures by category by clicking on the Category Column Heading 653. The user may sort measures by measure name by clicking on the Measure Column Heading 654. The user may sort measures by patient count by clicking on the Patients Column Heading 656. The user may sort measures by completion percentage by clicking on the Status Column Heading 655. This allows the user to identify patients where the physician has not recorded the quality service or clinical value required to meet the quality standard, without viewing the entire list of patients. Additionally, this sorting allows providers to more easily validate patients' services by review of patient charts.

The user may View Measure-wide results and click on a Measure 657 to view the results of individual patients in the Patient Measure Window 658.

The user may sort the patients by Response Status by clicking on the Response Button 659. The user may sort the patients by Patient Name by clicking on the Patient Name Button 660. The user may sort the patients by Eligibility Criteria by clicking on the Eligibility Criteria Button 661. The user may sort the patients by Effective Date by clicking on the Effective Date Button 662. The user may sort the patients by Response Code Response by clicking on the Code Button 663.

The user may open the help page by clicking on the Help Button 666. The user may return to the previous web page by clicking on the Iris List Button 665. The user may logout by clicking on the Logout Button 664. The user may exit the application by clicking on the Exit button 616 to close the application window.

FIG. 6D is a screen shot of a web page for reviewing the status of a patient's clinical condition, the quality standards being tracked for a patient, as well as for the input of new information and the correction of erroneous information, according to an example. This web page may be referred to as the Summary Window and is part of the web application 422. The summary window contains clinical observations of patient conditions as revealed by the database, and additional clinical risks faced by the patient as a consequence of analysis of the data. For example, the patient's clinical observations may include an indication of diabetes mellitus, along with additional diagnoses related to complications of diabetes mellitus, revealing that the patient is higher risk. The provider may use this information to review the clinical status of the patient at a glance.

The user may open the help page by clicking on the Help Button 666. The user may return to the previous web page by clicking on the Iris List Button 665.

The user may view the patient's last name under the Last Name Column Heading 669. The user may view the patient's first name under the First Name Column Heading 670. The user may view the patient's date of birth under the DOB Column Heading 671. The user may view the patient's gender under the Gender Column Heading 672. The user may view the patient's date of last visit under the Last Visit Column Heading 673.

The user may view the patient's status in the practice under the Status Column Heading 674. The user may click on the value under this heading to select a new value provided by the system management database 432. The user may enter a new value here to indicate that a patient is no longer active within the practice. The entry of this information may influence the physician's quality scoring by maintaining or removing the patient from the measurement database. This step is critical to the validation of claims data that has been coded into the system, but where the physician may have mistakenly assigned incorrect diagnoses or other clinical conditions to the patient.

The user may view the patient's preferred language under the Language Column Heading 675. The user may click on the value under this heading to select a new value provided by the system management database 432. The user may enter a new value here to indicate the patient's preferred language for communications. The language indicator may be used to direct communications from the physician to the patient with respect to quality of care and necessary clinical services.

The user may view the patient's consent for contact under the Contact Column Heading 676. The user may click on the value under this heading to select a new value provided by the system management database 432. The user may enter a new value here to indicate the whether the patient wishes to be contacted.

The user may view the patient's known email address under the Email Column Heading 677. The user may click on the value under this heading to enter a new value. The user may view the registries to which the patient belongs in the Observations Window 681. The user may view summaries of where there missing data elements in the Action Items Window 682. The user may also view the data collected for Clinical Measures in the Patient Facts Window 683. Here the user views the list of Clinical Measures that are pertinent to the patient listed at the top of the screen.

The user may sort the Clinical Measures by name by clicking on the Clinical Measure Column Heading 684. The user may sort the Clinical Measures by value by clicking on the Clinical Value Column Heading 685. The user may sort the Clinical Measures by the date reported by clicking on the Date Reported Column Heading 686. The user may sort the Clinical Measures by data source by clicking on the Source Column Heading 687. The Clinical Measures may be used to identify serious issues in the provider's patient population and for the individual patient. These Clinical Measures and Values are later calculated as part of the physician's quality scorecard process.

The user may double click on a Record 667 in the Patient Facts Window 683 to launch a pop-up window 693 like those depicted in FIG. 6F and FIG. 6G. The user may switch to view the Quality Reporting Window by clicking on the Quality Reporting Tab 679. The Quality Reporting Window is described in FIG. 6E. The user may switch to view the History Window by clicking on the History Tab 680. The History Window is described in FIG. 6H. The History Window contains relevant sequential clinical information about the patient that may assist the provider in comparing values of previous and current patient conditions.

FIG. 6E is a screen shot of a web page for reviewing the status of measures for a patient, as well as for the input of new information and the correction of erroneous information, according to an example. This web page may be referred to as the Quality Reporting Window, and is part of the web application 422. The Quality Reporting Window is used to record specific actions taken by the provider to deliver quality services to the patient, or to report the clinical status of a patient with respect to a particular quality standard. The user may open the help page by clicking on the Help Button 666. The user may return to the previous web page by clicking on the Iris List Button 665.

The user may view the patient's last name under the Last Name Column Heading 669. The user may view the patient's first name under the First Name Column Heading 670. The user may view the patient's date of birth under the DOB Column Heading 671. The user may view the patient's gender under the Gender Column Heading 672. The user may view the patient's date of last visit under the Last Visit Column Heading 673.

The user may view the patient's status in the practice under the Status Column Heading 674. The user may click on the value under this heading to select a new value provided by the system management database 432. The user may enter a new value here to indicate that a patient is no longer active within the practice.

The user may view the patient's preferred language under the Language Column Heading 675. The user may click on the value under this heading to select a new value provided by the system management database 432. The user may enter a new value here to indicate the patient's preferred language for communications.

The user may view the patient's consent for contact under the Contact Column Heading 676. The user may click on the value under this heading to select a new value provided by the system management database 432. The user may enter a new value here to indicate whether the patient wishes to be contacted. The user may view the patient's known email address under the Email Column Heading 677. The user may click on the value under this heading to enter a new value.

The user may double click on a Record 667 in the Quality Reporting Services Window 688 under the Clinical Value Column Heading 685 to launch a pop-up window 693 like those depicted in FIG. 6F and FIG. 6G.

The user may sort measures by service provider by clicking on the Service Provider Column Heading 689. The user may sort measures by category by clicking on the Category Column Heading 653. The user may sort measures by measure name by clicking on the Quality Measure Column Heading 654.

The user may sort measures by measure status by clicking on the Patient Eligibility Column Heading 690. The user may click on a record under the Patient Eligibility Column Heading 690 and select a new status for that patient-measure combination: the user may retain the default status of “Active,” or change the status to one of a list of possibilities that explain why the patient-measure combination is invalid.

The user may sort measures by eligibility criteria by clicking on the Eligibility Criteria Column Heading 691. The user may sort measures by clinical value by clicking on the Clinical Value Column Heading 685. The user may sort measures by quality code by clicking on the Quality Code Column Heading 692. The user may sort measures by date reported by clicking on the Date Reported Column Heading 686.

The user may switch to the Summary Window by clicking on the Summary Tab 678. The Summary Window is described in FIG. 6D. The user may switch to view the History Window by clicking on the History Tab 680. The History Window is described in FIG. 6H.

FIG. 6F is a screen shot of a web page Pop-up Window 693 for entering quality codes in response to a measure which a patient has been included; according to an example and may be used to submit Quality Codes and Clinical Values in response to the assignments of patients to Measures.

The user may select a single combination of a Clinical Value and a Quality Code by clicking on the Radio Button 695 that occupies the same line. The coding options given to the user are limited by the MPR database 121 to the codes that are directly applicable to the Measure selected either when a Record 667 under the Clinical Value Column Heading 685 in the Quality Reporting Services Window 688 or when a Record 667 in the Patient Facts Window 683 is double-clicked.

The user may select a date to associate with the selected Quality Code or Clinical Value by clicking on Date Button 694 and clicking on the appropriate date.

The user may commit the Quality Code and Clinical Values selections made with Radio Button 695 and Date Button 694 by clicking on the Submit Button 696. Clicking the Submit Button 696 instructs the web application 422 to append the corresponding patient-provider-measure record in the MPR database 121 with the information selected.

The user may close the Pop-up Window 693 without committing any changes to the MPR database 121 by clicking the Cancel Button 697.

FIG. 6G is a screen shot of a web page Pop-up Window 693 for entering quality codes that pertain to specific clinical metrics in response to a measure which a patient has been included; according to an example; and may be used to submit Quality Codes in response to the assignments of patients to Quality Measures.

The user may select a single combination of a Clinical Value and a Quality Code by clicking on the Radio Button 695 that occupies the same line. The coding options given to the user are limited by the MPR database 121 to the codes that are directly applicable to the Measure selected either when a Record 667 under the Clinical Value Column Heading 685 in the Quality Reporting Services Window 688 or when a Record 667 in the Patient Facts Window 683 is double-clicked.

The user may select a date to associate with the selected Quality Code or Clinical Value by clicking on Date Button 694 and clicking on the appropriate date.

The user may commit the Quality Code and Clinical Values selections made with Radio Button 695 and Date Button 694 by clicking on the Submit Button 696. Clicking the Submit Button 696 instructs the web application 422 to append the corresponding patient-provider-measure record in the MPR database 121 with the information selected.

The user may close the Pop-up Window 693 without committing any changes to the MPR database 121 by clicking the Cancel Button 697.

FIG. 6H is a screen shot of a web page for reviewing the data history for a patient as well as for the input of new information and the correction of erroneous information, according to an example. This web page may be referred to as the History Window, and is part of the web application 422.

The user may open the help page by clicking on the Help Button 666. The user may return to the previous web page by clicking on the Iris List Button 665.

The user may view the patient's last name under the Last Name Column Heading 669. The user may view the patient's first name under the First Name Column Heading 670. The user may view the patient's date of birth under the DOB Column Heading 671. The user may view the patient's gender under the Gender Column Heading 672. The user may view the patient's date of last visit under the Last Visit Column Heading 673.

The user may view the patient's status in the practice under the Status Column Heading 674. The user may click on the value under this heading to select a new value provided by the system management database 432. The user may enter a new value here to indicate that a patient is no longer active within the practice.

The user may view the patient's preferred language under the Language Column Heading 675. The user may click on the value under this heading to select a new value provided by the system management database 432. The user may enter a new value here to indicate the patient's preferred language for communications.

The user may view the patient's consent for contact under the Contact Column Heading 676. The user may click on the value under this heading to select a new value provided by the system management database 432. The user may enter a new value here to indicate the whether the patient wishes to be contacted.

The user may view the patient's known email address under the Email Column Heading 677. The user may click on the value under this heading to enter a new value.

The user may switch to view the Summary Window by clicking on the Summary Tab 678. The History Window is described in FIG. 6D. The user may switch to view the Quality Reporting Window by clicking on the Quality Reporting Tab 679. The Quality Reporting Window is described in FIG. 6E.

The user may view all the records from the datamarts 138 that were imported into the MPR database 121 in the Patient Services History Window 698 as they pertain to the patient named at the top of the web page.

The Patient Services History Window 698 may display to the user, among other information, Dates of Service, Patient Age, Diagnosis Codes, Procedure Codes, Procedure Modifier Codes, and Provider Names which can each be used by the user to sort the display order of the information. In the Patient Facts History Window 699, the user may view all the records as they pertain to the patient named at the top of the web page submitted into the MPR database 121 via Pop-Up Window 693 after having double-clicking on a Record 667 in the Patient Facts Window 683. The Patient Facts History Window 699 may display to the user, among other information, Dates of Service, Patient Age, Diagnosis Codes, Procedure Codes, Procedure Modifier Codes, and Provider Names which can each be used by the user to sort the display order of the information.

FIG. 6I is a screen shot of a web page for selecting one of two possible ways to generate data capture tools for quality management, according to an example. This web page may be within the web application 422.

The user may click on the hyperlink Batch Prompts 613. Doing so will load the web page described in FIG. 6J. The user may click on the hyperlink Pick Patients 615. Doing so will load the web page described in FIG. 6L.

The user may open the help page by clicking on the Help Button 666. The user may return to the previous web page by clicking on the Iris List Button 665. The user may logout by clicking on the Logout Button 664.

FIG. 6J is a screen shot of a web page for selecting groups of patients based on last visit date for the bulk creation of data capture tools for quality management, according to an example. This web page may be within the web application 422.

The user may select the timeframe for patient last visits by clicking the Radio Button 617 next to the desired selection. The user may submit to the web application 422 the timeframe selected by Radio Button 617 by clicking on the Continue Button 619. Doing so will load the web page described in FIG. 6K.

The user may open the help page by clicking on the Help Button 666. The user may return to the previous web page by clicking on the Iris List Button 665. The user may logout by clicking on the Logout Button 664.

FIG. 6K is a screen shot of a web page for selecting groups of patients based on registry membership for the bulk creation of data capture tools for quality management, according to an example. This web page may be within the web application 422.

The user may select the registry the patients belong to by clicking the Radio Button 621 next to the desired selection.

The user may submit to the web application 422 the registry selected by Radio Button 621 and initiate data capture tool generation by clicking on the Generate Button 623. Doing so will assemble a document (a sample of which is depicted in Fig. Q) composed of graphics (a sample of which is depicted in Fig. P) and content specifically personalized to the individual patient, designed to aid the user in the submission of Quality Codes after a patient visit.

The user may open the help page by clicking on the Help Button 666. The user may return to the previous web page by clicking on the Iris List Button 665. The user may logout by clicking on the Logout Button 664.

FIG. 6L is a screen shot of a web page for selecting groups of patients based on provider and last visit date for the bulk creation of data capture tools for quality management, according to an example according to an example. This web page may be within the web application 422.

The user may select the provider and the timeframe for patient last visits by clicking the Dropdown Box 617 then clicking the desired selection. The user may submit to the web application 422 the timeframe selected by Dropdown Box 617 by clicking on the Continue Button 619. Doing so will load the web page described in FIG. 6M.

The user may open the help page by clicking on the Help Button 666. The user may return to the previous web page by clicking on the Iris List Button 665. The user may logout by clicking on the Logout Button 664.

FIG. 6M is a screen shot of a web page for selecting groups of patients based on registry membership for the bulk creation of data capture tools for quality management, according to an example. This web page may be within the web application 422.

The user may select the registry the patients belong to by clicking the Radio Button 621 next to the desired selection. The user may submit to the web application 422 the registry selected by Radio Button 621 by clicking on the Continue Button 619. Doing so will load the web page described in FIG. 6N.

The user may open the help page by clicking on the Help Button 666. The user may return to the previous web page by clicking on the Iris List Button 665. The user may logout by clicking on the Logout Button 664.

FIG. 6N is a screen shot of a web page for selecting groups of patients based on patient name for the creation of data capture tools for quality management, according to an example. This web page may be within the web application 422.

The user may select the patients for whom the data capture tools are needed by clicking the Check Boxes 625 next to each appropriate patient.

The user may submit to the web application 422 the patients selected by Check Boxes 625 and initiate data capture tool generation by clicking on the Generate Button 623. Doing so will assemble a document (a sample of which is depicted in Fig. Q) composed of graphics (a sample of which is depicted in Fig. P) and content specifically personalized to the individual patient, designed to aid the user in the submission of Quality Codes after a patient visit.

The user may open the help page by clicking on the Help Button 666. The user may return to the previous web page by clicking on the Iris List Button 665. The user may logout by clicking on the Logout Button 664.

FIG. 6P is a sample of a component used in the dynamic construction of data capture tools for quality management according to an example.

FIG. 6Q is a sample of a fully constructed data capture tool, personalized for an individual patient's specific measure assignments, according to an example.

FIG. 6R is a screen shot of a sample view, according to an example. This view may be used to explain how the user may perform the actions listed above with reference to block 512 within the web application 422.

The user may select and open another pre-written view by selecting an analysis module 626 on the menu bar 602. For example, the user may select the physician module. A drop down menu of initial views 628 for that analysis module 626 may appear. The user may then select an initial view 628 as a starting point of an analysis.

The user may regenerate the current pre-written view by clicking the restore button 604. This feature may be useful if the user wishes to begin a new analysis or provide a known starting point. The user may display the query code by clicking on the MDX button 606. The user may review the query code to determine what query the system 300 is performing. The user may send the contents of the view to Excel by clicking the Excel button 608. Once the data is exported to Excel, the user may use the features within Excel to perform data manipulations, such as creating graphs and charts.

The user may hide or expose a field list 634 by clicking the Fields button 610. The fields list 634 may include measures 630 and dimensions 632, which may be selected by the user to modify the view. By hiding the field list 634, the application 422 may have more workable space.

The user may modify the current view by clicking on a folder in the field list 634 and dragging a new measure 630 or dimension 632 into a Columns Area 618, a Rows Area 620, or a Filter Area 622. The measures 630 may be quantities generated from the data. For example, the measures 630 include counts (e.g., patients, visits, days) and currency (e.g., payments, charges, adjustments). The measures 630 may be calculated and presented in accordance with the analytic definitions.

The dimensions 632 may be categories of data in which the measures 630 may be viewed. The dimensions 632 may allow the user to group measures 630 in logical ways, which may provide the user with analytical information. The dimensions 632 may be hierarchically designed to allow very fine granularity to distinguish data. The dimensions 632 may be built to meet the requirements of the analytical definitions.

The user may save a modified view by selecting My View 614, and clicking on Add View from a drop down menu. The user may exit the application by clicking on the Exit button 616 to close the application window

### Clinical Quality Management Example

FIGS. 6A-6R visually represent the manner in which providers may review quality of care provided to patients as compared with national standards. It is difficult for physicians to identify problems of quality across the practice as a whole. For example, a physician may not realize that as many as 30% of his or her practice is diabetic, and that a significant portion of these have further diabetic complications. Because the nature of a physician practice is focused on problems that emerge on a patient-by-patient basis as they present with clinical issues, it is difficult to see quality trends across the practice. Also, the time constraints of a single visit make it likely that many services required by quality standards are missed.

Web application 422 allows the provider to retrospectively review quality that has been delivered to patients in the aggregate, and allows corrective measures for individual patients. Using the sample in FIG. 6C, the provider has selected a registry for Coronary Artery Disease, where patients should have been prescribed a particular beta-blocker medication following myocardial infarction. Failure to prescribe this medication has been linked to poor patient outcomes. Review of the patients in the registry indicate that many patients have not been reported as receiving prescriptions for this medication. If the values assigned to the patient represent unreported—as distinct from undelivered—care, Web Application 422 allows the provider to correct the patient record to indicate that the medication was prescribed. If the review of patients indicate that the patients did not receive the appropriate prescriptions, the results of this analysis will be part of the physician's quality scorecard.

In addition, Web Application 422 creates the basis for both review and scoring of physician quality. The results of individual patients are displayed for validation, updates, and corrections. This allows a measure of control for providers in their own quality scorecard.

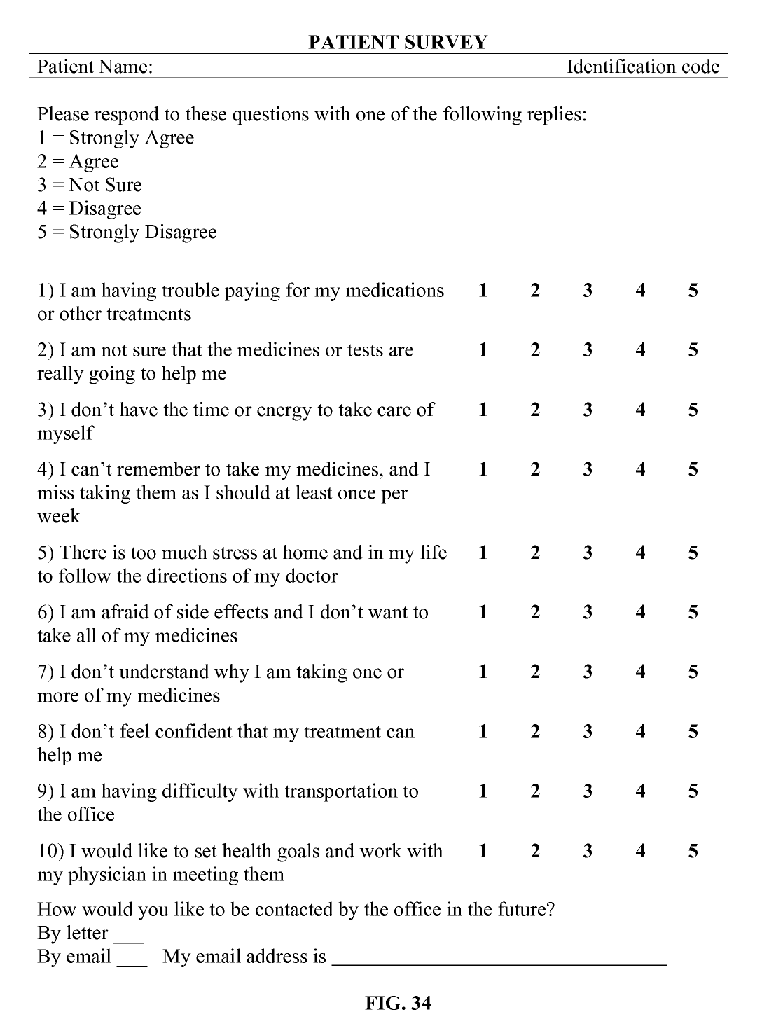

Also, Web Application 422 is important for review of clinical issues that must be addressed across an entire practice rather than individually. For example, knowledge that a high level of diabetic patients with unmanaged blood pressure exists in a practice serves to inform the physician that additional services should be organized for these patients as a group. The physician may wish to use the survey in FIG. 34 to query patients on the reasons for poor blood pressure management, or the physician may wish to review other clinical inputs, such as prescribed medications, to resolve the issue for patients. Without Web Application 422, physicians do not have access to clinical information that is reflected in the whole of their practice.

### Declining Practice Revenues Example

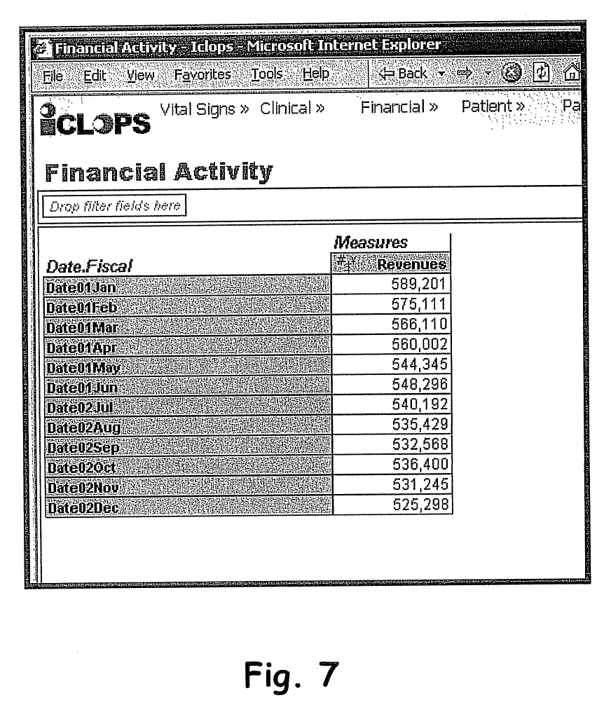

FIGS. 7-13 are screen shots of sample views of results using the system 400 depicted in FIG. 4. Lacking information on performance trends and not knowing where to find the information is one of many problems faced by practices today. For example, a practice may have difficulty determining the source, or even the existence, of declining practice revenues. As described below with reference to FIGS. 7-13, the system 400 may provide a practice with the ability to track the source of revenue changes. It is understood that the data displayed in the screen shots is not actual data, but a representation of the type of data that may be used to analyze the problems encountered by practices.

FIG. 7 is a screen shot of practice revenues, according to an example. This view may be created by dragging the Revenues Measure into the Columns Area, and the Month level of the Date Fiscal dimension into the Rows Area. The result may be a view that answers the initial question of whether the revenues are in decline or not. The numbers shown in FIG. 7 do indicate that the monthly revenues for this practice are down over 10% for the twelve month period shown.

After reviewing the results depicted in FIG. 7, a practice may now have the information that the practice has experienced a revenue decline. The practice may then want to know why there has been a revenue decline and what the practice do to change the trend, if anything. The system 400 may be used to evaluate different factors to determine the cause of the revenue decline. For example, the system 400 may be used to determine if the revenue decline is a result of the practice treating fewer patients.

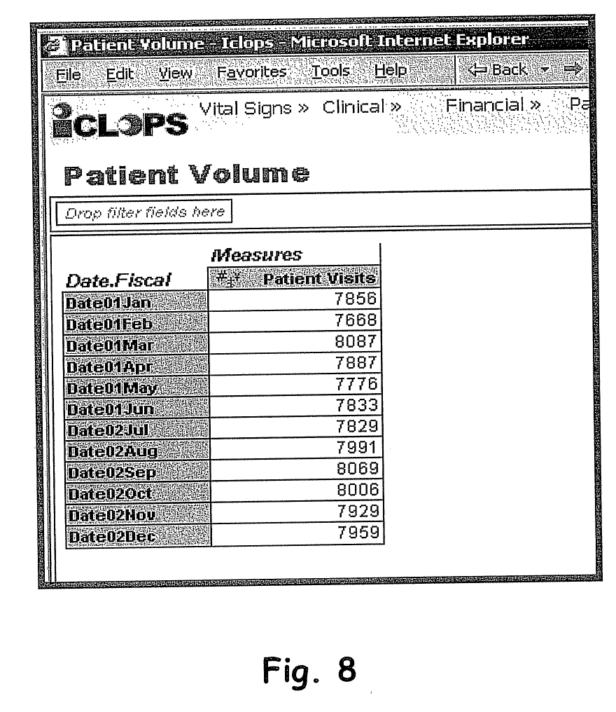

FIG. 8 is a screen shot of patient visits, according to an example. This view may be created by dragging the Revenues Measure out of the Columns Area and dragging the Patient Visits measure into the Columns Area. The resulting view depicted in FIG. 8 shows that the number of visits has been stable for the time period in question. Since the number of patient visits is stable, that factor may be ruled out as a contributor to the declining revenue. It may be helpful to determine if the practice is charging less overall for its services.

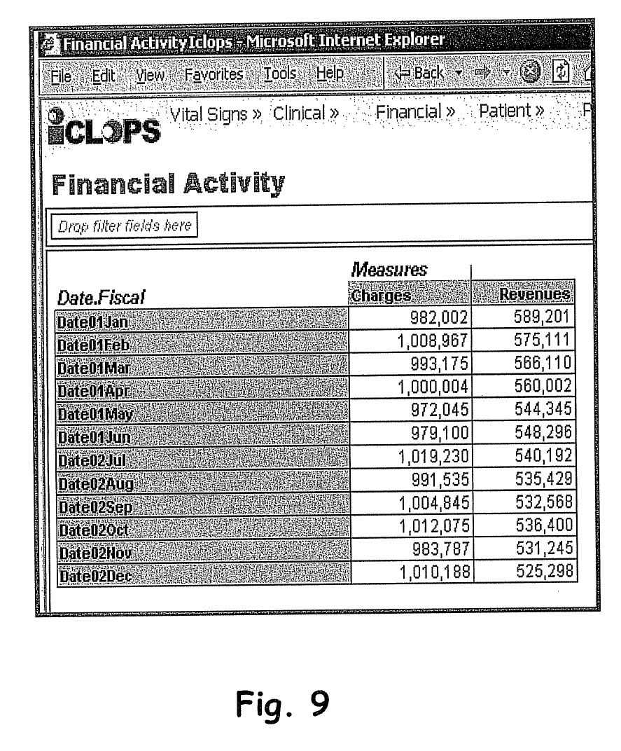

FIG. 9 is a screen shot of charges and revenues, according to an example. This view may be created by dragging the Patient Visits measure out of the Columns Area and dragging the Charges and Revenues measures into the Columns Area. The resulting view depicted in FIG. 9 shows the charges and revenues side by side, and indicates that charges have been stable for the time period in question. Since the charges for services have remained on average unchanged, the cause of the declining revenue now appears to be within the payment and collection process of the practice. Since some types of payers reimburse the practice at different rates, it would be beneficial to investigate if the mix of payer types has changed in the given period.

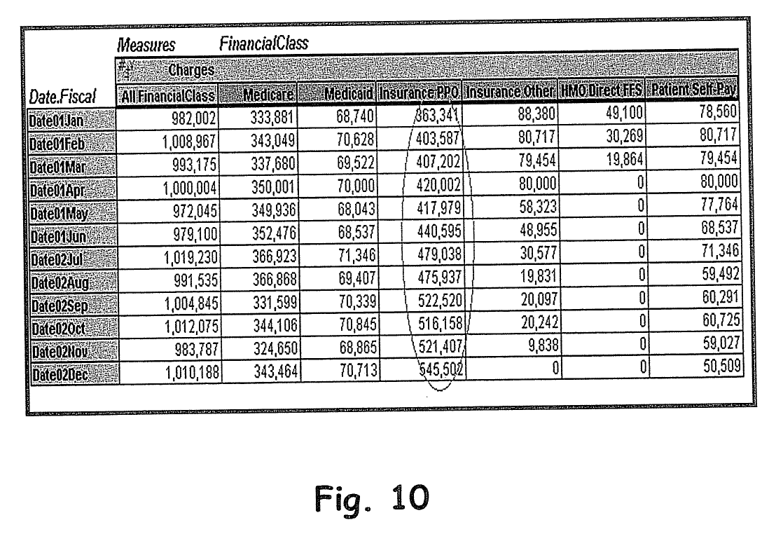

FIG. 10 is a screen shot of charges by financial class, according to an example. This view may be created by dragging the Revenues measure out of the Column Area and dragging the Financial Class dimension into the Columns Area. The resulting view depicted in FIG. 10 shows charges for services across the various financial classes for the time period. Financial classes are convenient way to group similar types of insurance plans together. By expanding out the financial class members, the practice can see that the charges for the payers in the Insurance PPO category (circle added) have increased by 50% while charges for other categories have either remained stagnant or dropped sharply. This trend may indicate that payers in the Insurance PPO financial class have become a much more significant component of overall charges, starting at 37% of charges and growing to 55% of charges by the end of the period. It may be helpful to determine if the revenue trends match the trends for charges.

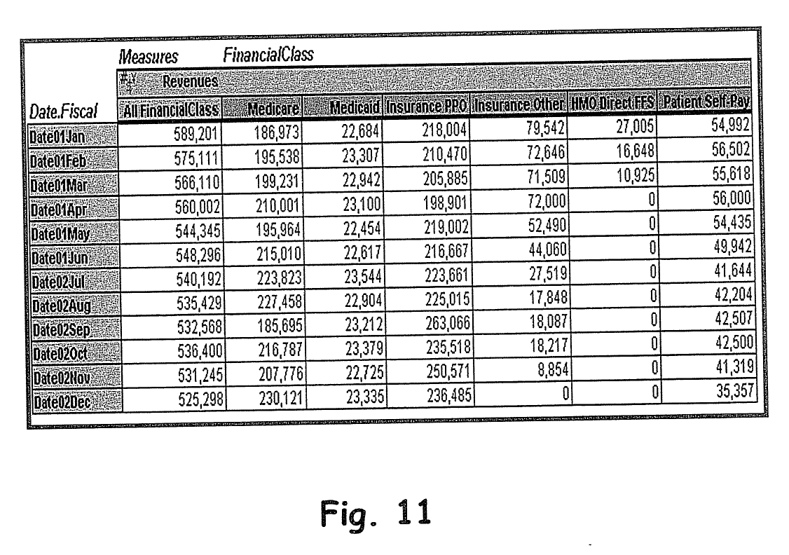

FIG. 11 is a screen shot of revenues by financial class, according to an example. This view may be created by dragging the Charges measure out of the Columns Area and dragging Revenues measure into the Columns Area. The resulting view depicted in FIG. 11 shows revenues across the various financial classes for the time period, and may be created to reveal any correlation with the charge trend. The charges had risen significantly for the payers in the Insurance PPO financial class, but the revenues are fairly stagnant and have increased by only 8%. Other financial classes show steep drops in revenues that match with the charges trend observed earlier.

From the information presented in the view depicted in FIG. 11, the practice may question whether the revenue decline may be caused by factors related to payers in the Insurance PPO financial class. However, there may be other reasons for the revenue decline.

For example, a problem may exist in processes at the billing service, affecting collections. As another example, a problem may exist with the payers themselves. The next step to identifying the source of the revenue decline may be to investigate the rate of collection, which may be a billing service responsibility.

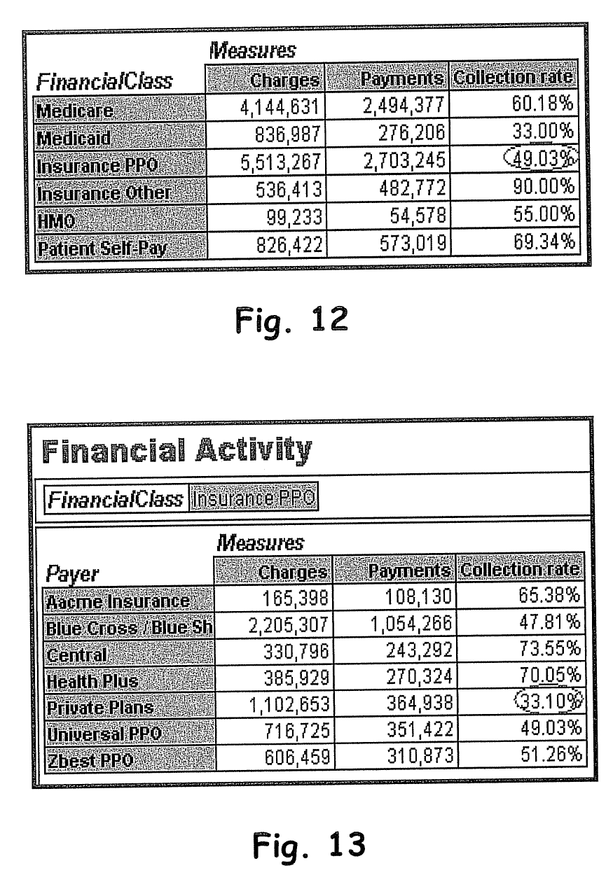

FIG. 12 is a screen shot of collection rates, according to an example. This view may be created by rolling up the Date Fiscal dimension, dragging the Financial Class Name level of the Financial Class dimension into the rows area, and dragging the Charges and Collection Rate measures into the Columns Area. The time in the Date Fiscal dimension may be rolled up in order to cover the given time period as an aggregate. As a result, FIG. 12 depicts the collection rates received by payers by Financial Class.

Experience in healthcare business suggests that collecting 60% of charges from Medicare and 33% of charges from Medicaid is normal even for effective billing services.

However, a collection rate of 49% (circle added) for Insurance PPO payers is much below normal. If the revenue decline was a result of poor billing services, then below normal collection rates may not be limited to one type of claim. As such, the billing service may be ruled out as the source of the revenue decline. The declining revenues may be caused by one or more of the payers in the Insurance PPO category. The system 400 may be used to examine the collection rates for each payer.

FIG. 13 is a screen shot of collection rates by payer, according to an example. This view may be created by dragging the Financial Class Name level of the Financial Class dimension into the Filter Area and selecting Insurance PPO and by dragging the Payer Name level of the Payer dimension into the Rows Area. The resulting view depicted in FIG. 13 shows charges, payments, and collection rates for each Payer in the Insurance PPO category over the time period. Looking at the collection rates for each Payer, the practice may determine that the Payer called “Private Plans” is driving the revenue decline (circle added).

Since Private Plans does not pay well and is a significant portion of the Insurance PPO Financial Class, the practice may understand that if the Insurance PPO gains a greater share of the business, overall revenues of the practice may continue to decline. Knowing this information may allow the practice to address the problem effectively. For example, the practice may wish to renegotiate its contracts with the problem payer or entice more patients from more profitable sources.

As shown with reference to FIGS. 7-13, a practice can use the system 400 to evaluate their business operations and improve business performance. While the example above depicts how a practice may use the analytical data from the cubes 140 to evaluate revenue declines, the practice may use the analytical data in a variety of other ways.

### Other Financial Examples

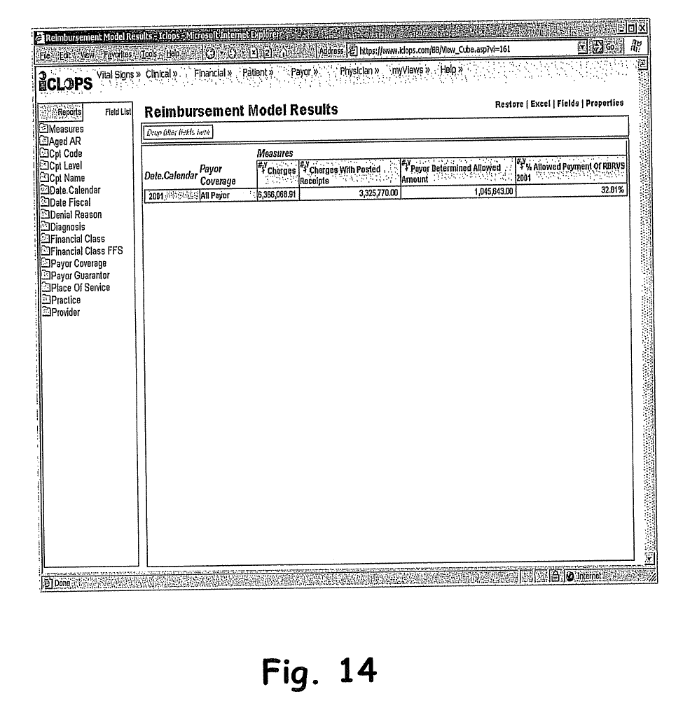

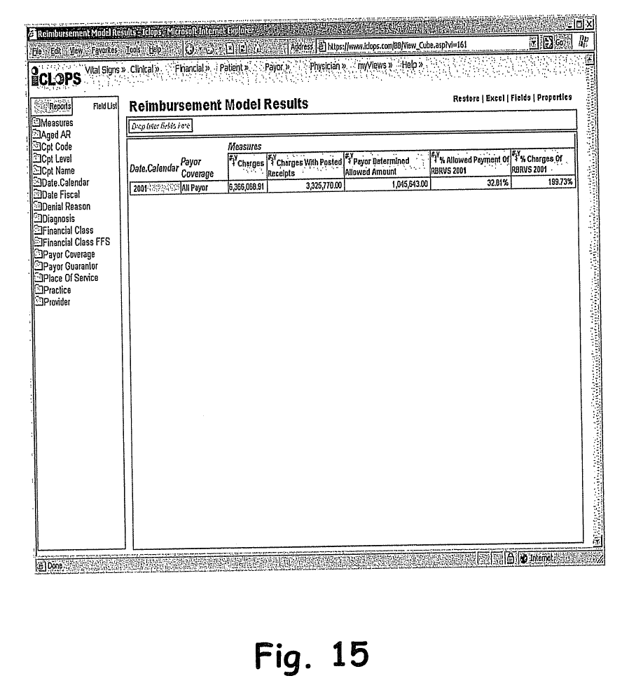

FIG. 14 is a screen shot of financial data, according to an example. The system 400 may be used to help manage the business aspects of a physician practice in addition to patient care. The view depicted in FIG. 14 shows the following analytical data for the calendar year 2001:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.

FIG. 15 is a screen shot of data shown in FIG. 14 including percent charges of RBRVS, according to an example. This view may be created by dragging the % Charges of RBRVS into the Columns Area of the view. The resulting view depicted in FIG. 15 shows the following analytical data for the calendar year 2001:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.

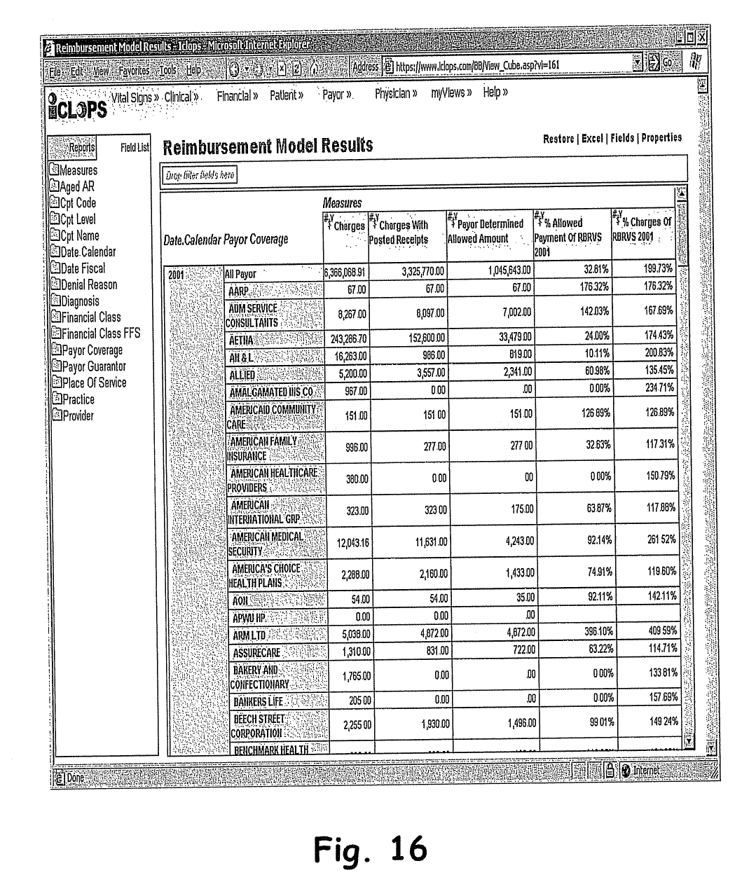

FIG. 16 is a screen shot of data shown in FIG. 15 by payer, according to an example. This view was created by clicking on All Payer dimension already in the view. Since All Payer was at the top of a hierarchy of members, clicking on it expands the list to show all members at the next level. The members below All Payer include the list of all payers that have had charges claimed against them for 2001, and for those individual payers the view shows:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.

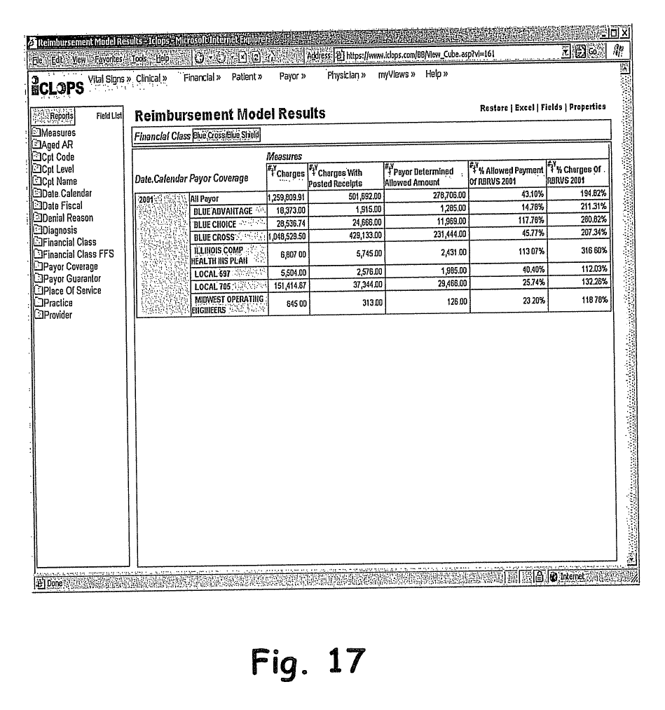

FIG. 17 is a screen shot of data shown in FIG. 16 by a selected financial class, according to an example. This view may be created by dragging the Financial Class Name level of the Financial Class dimension into the Filter Area, and selecting to filter by Blue Cross. The resulting view depicted in FIG. 17 shows the list of all payers in the Blue Cross financial class that have charges claimed against them for 2001, and for those individual payers the view shows:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.

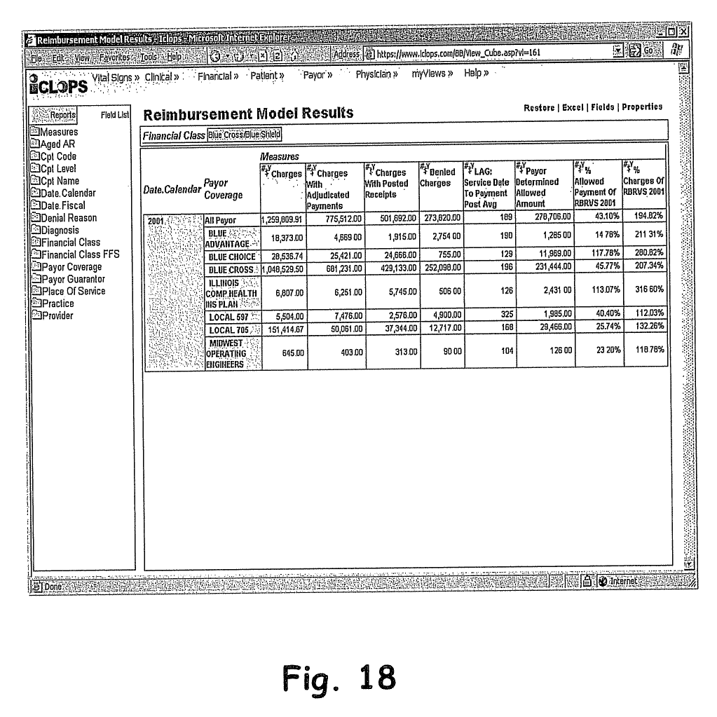

FIG. 18 is a screen shot of data shown in FIG. 17 including charges with adjudicated payments, denied charges, and payment lag, according to an example. This view was created by dragging the Charges with Adjudicated Payments, Denied Charges, and Service to Payment Lag into the Columns Area. The resulting view depicted in FIG. 18 shows the list of all payers in the Blue Cross financial class that have had charges claimed against them for 2001, and for those individual payers the view shows:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.
Charges with Adjudicated Payments—A total of the charges were had any kind of financial activity (payments, adjustments or denials).
Denied Charges—A total of the charges for claims denied by payers.
Service to Payment Lag—A count of how many days elapsed for the payers to send payment for claims, averaged over the time period.

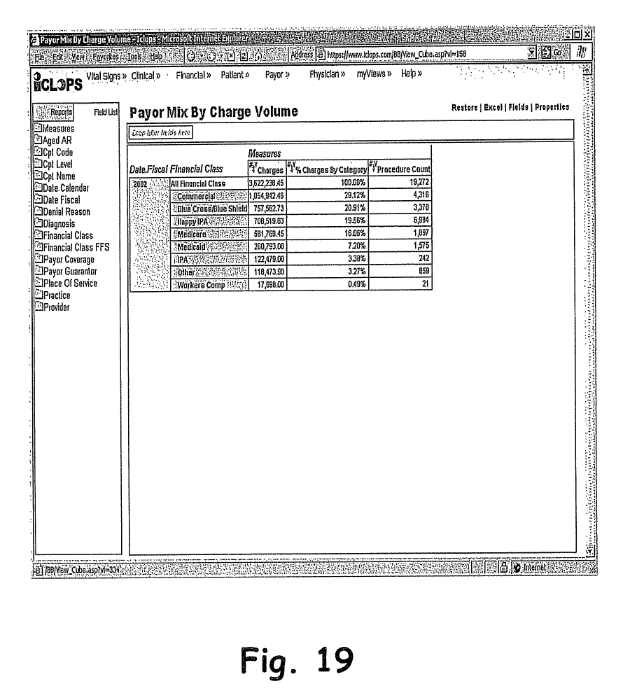

FIG. 19 is a screen shot of financial data, according to another example. This initial view shows for year 2002 the Charges, number of procedures billed for, and the % of total charges for each financial class. This view may be used to evaluate the relative amounts of business a practice has with the various types of payers. This type of information is typically not readily available to practice managers.

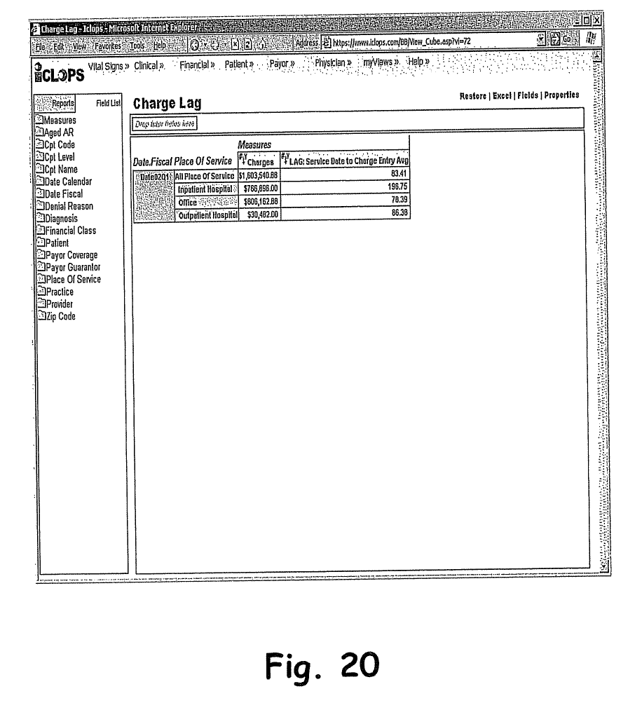

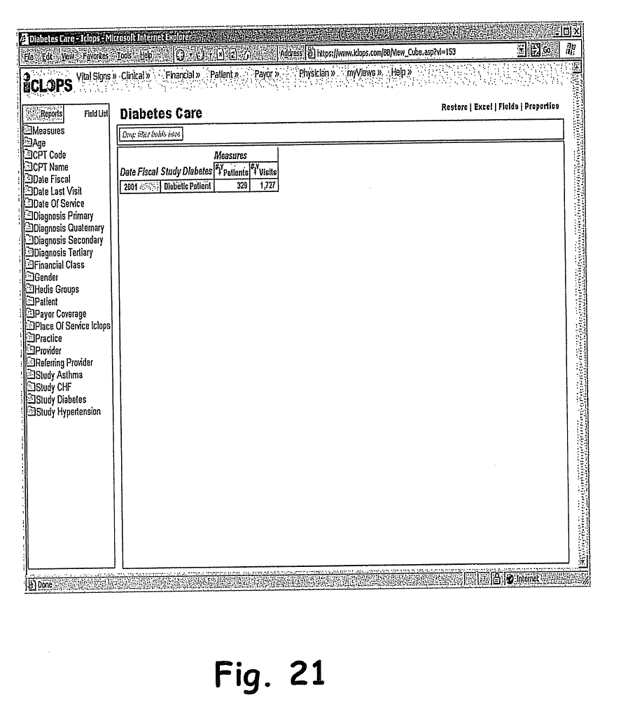

FIG. 20 is a screen shot of financial data, according to another example. This is an initial view that shows the user how many days elapsed for charges to be entered into the billing system as reflected by different places of service. This view may allow a practice administrator to identify potential bottlenecks in the billing process as reflected by the differing operational procedures in the different places of service.

Clinical Examples

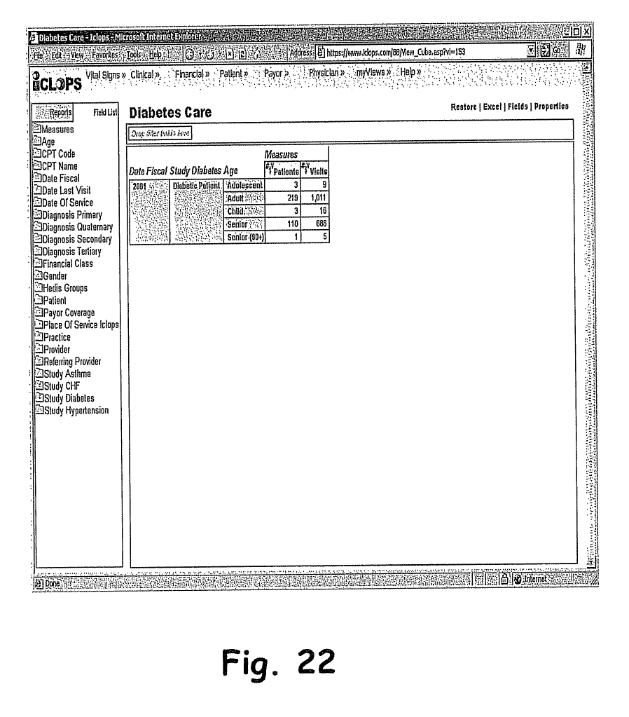

FIGS. 21-30 are screen shots of sample views of results using the system 400 depicted in FIG. 4. While the previous example demonstrated how a practice could use the system 400 to understand the financial nature of the practice's business, FIGS. 21-30 demonstrate how a practice can use the system 400 to understand the clinical nature of the practice's business.

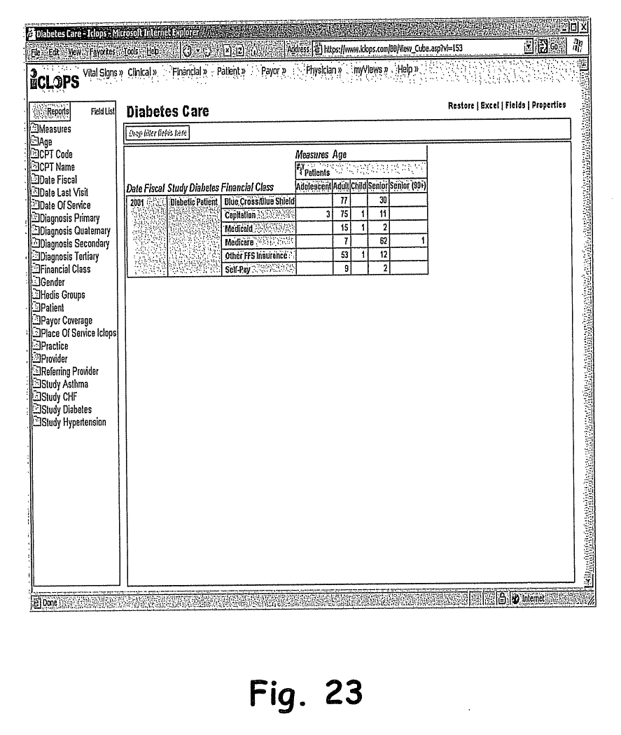

FIG. 21 is a screen shot of a number of diabetic patients and a number of visits these patients made to a practice in a given time, according to an example. While the example provides analytic data regarding diabetic patients, it is understood that the system 400 may analyze patient data for a variety of medical diagnosis. This view may be created by dragging the Patient Visit Count measure into the Columns Area. The resulting view depicted in FIG. 21 may answer the practice's question regarding how many patients the practice has seen with a particular diagnosis and how many times they have visited the practice within a given time frame. This information may allow a physician to readily track and manage the care received by these patients. FIGS. 22-30 show a progression of analyses as performed by the system 400.

FIG. 22 is a screen shot of data shown in FIG. 21 separated by age category, according to an example. This view may be created by dragging the Age Group level of the Age dimension into the Rows Area to show the distribution of the Diabetic patients by age group. The age groups in the Age dimension may be fully customizable.

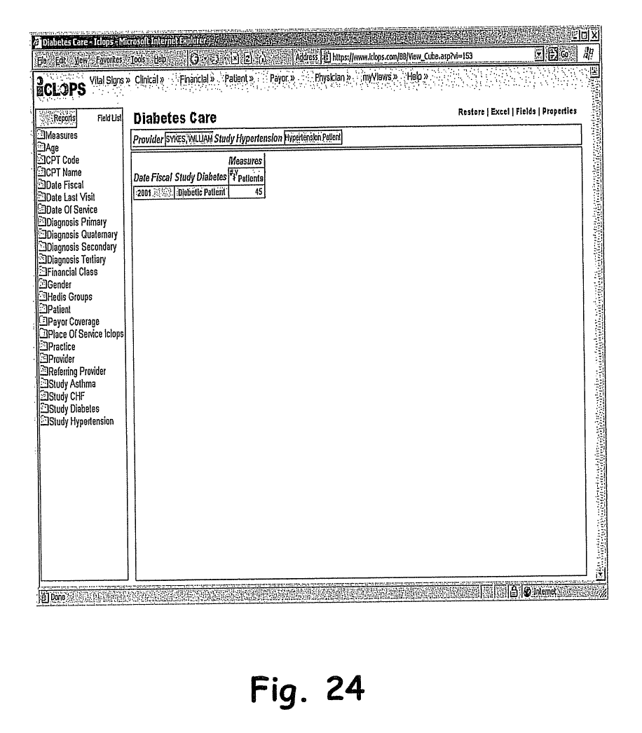

FIG. 23 is a screen shot of data shown in FIG. 22 separated by financial class, according to an example. This view may be created by dragging the Patient Visit Count measure out of the Columns Area, dragging the Financial Class Name level of the Financial Class dimension into the Columns Area, and moving the Age dimension to the Columns Area. The resulting view depicted in FIG. 23, may provide the practice information regarding how the diabetic patients are distributed among age groups as well as what type of insurance coverage they had during 2001.

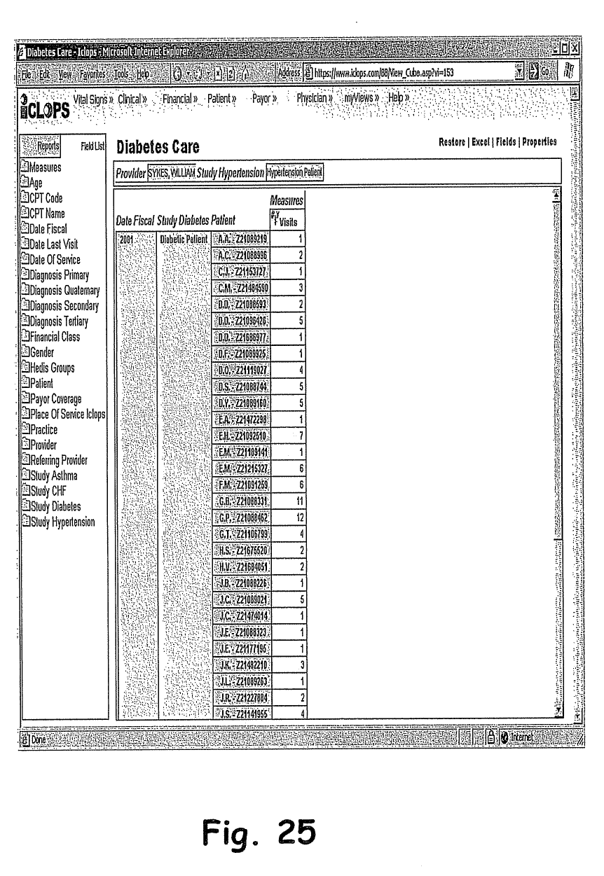

FIG. 24 is a screen shot of a number of diabetic patients that also suffer from hypertension, according to an example. This view may be created by dragging both the Financial Class and Age dimensions from the Columns Area and dragging the Provider dimension and the Study Hypertension dimension into the Filter Area of the view. The Filter Area may allow users to select one or more members from a dimension to filter the query results accordingly. As depicted in FIG. 24, the user has filtered the data to show the count of diabetic patients of a doctor (i.e., William Sykes) who also suffer from hypertension for 2001.

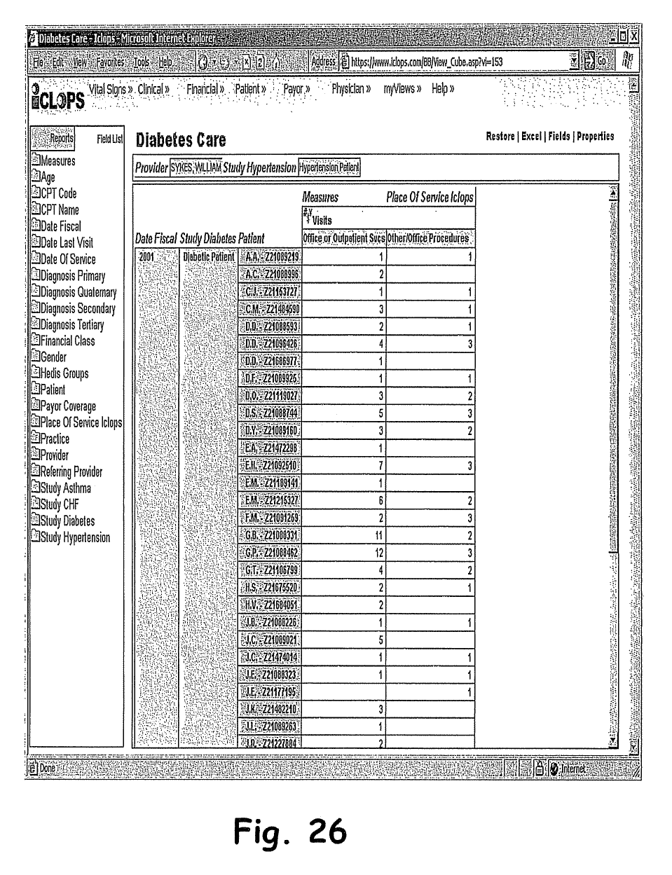

FIG. 25 is a screen shot listing diabetic patients that also suffer from hypertension and associated number of visits, according to an example. This view may be created by dragging the Patient Name level of the Patient dimension into the Rows Area of the view, dragging the Visits Count measure into the Columns Area of the view, and dragging the Patient Count measure out of the Columns Area. The resulting view depicted in FIG. 25 may allow the practice to receive data regarding individual patients. This view shows the diabetic patients by name and how many visits each patient had during 2001. The names of diabetic-hypertensive patients who had no visits in 2001 are not be listed in the view depicted in FIG. 25 as the system 400 may discard results with empty data.

FIG. 26 is a screen shot listing place of service, according to an example. This view may be created by dragging the Place of Service Group level of the Place of Service dimension into the Columns Area of the view. The Place of Service dimension is created based on the CPT codes indicative of particular possible places of service used for the visit. The resulting view depicted in FIG. 26 shows the diabetic-hypertensive patients by name and how many visits they each had, and the type of facility in which the visit occurred in during 2001. Analyzing the place of service may be important in gauging workflow or operational issues of the practice.

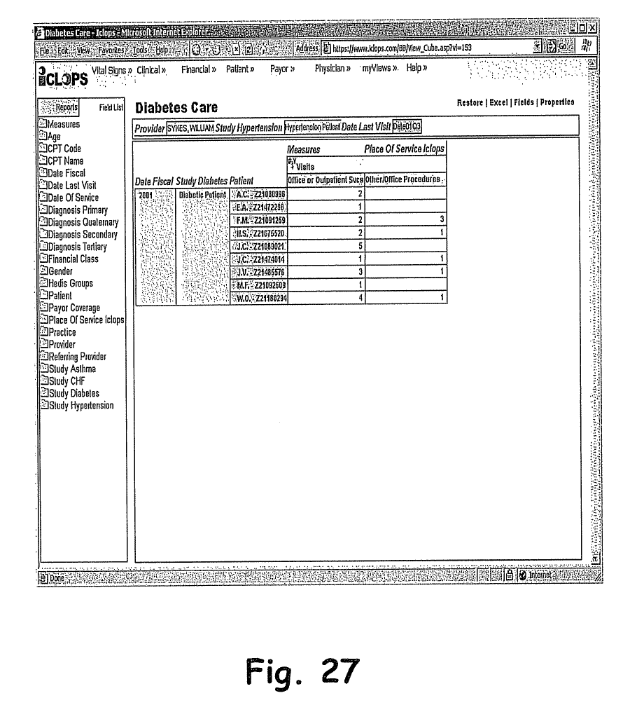

FIG. 27 is a screen shot of data shown in FIG. 26 for patients that visited a practice in the last two quarters, according to an example. This view may be created by dragging the Quarter level of the Date of Last Visit dimension into the Filter Area, filtering for the time frame the two previous quarters to present in the view. The resulting view depicted in FIG. 27 shows the diabetic-hypertensive patients by name, how many visits they each had, and the type of facility in which the visit occurred, all for the previous two quarters. Patients with chronic conditions require specific regimens of care and knowing when a patient was last seen can allow physicians to better manage those patient populations.

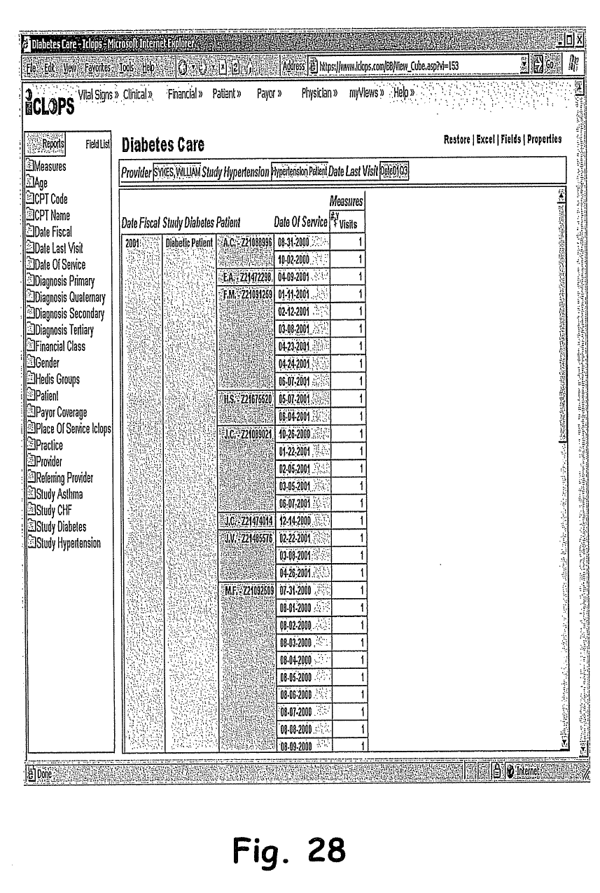

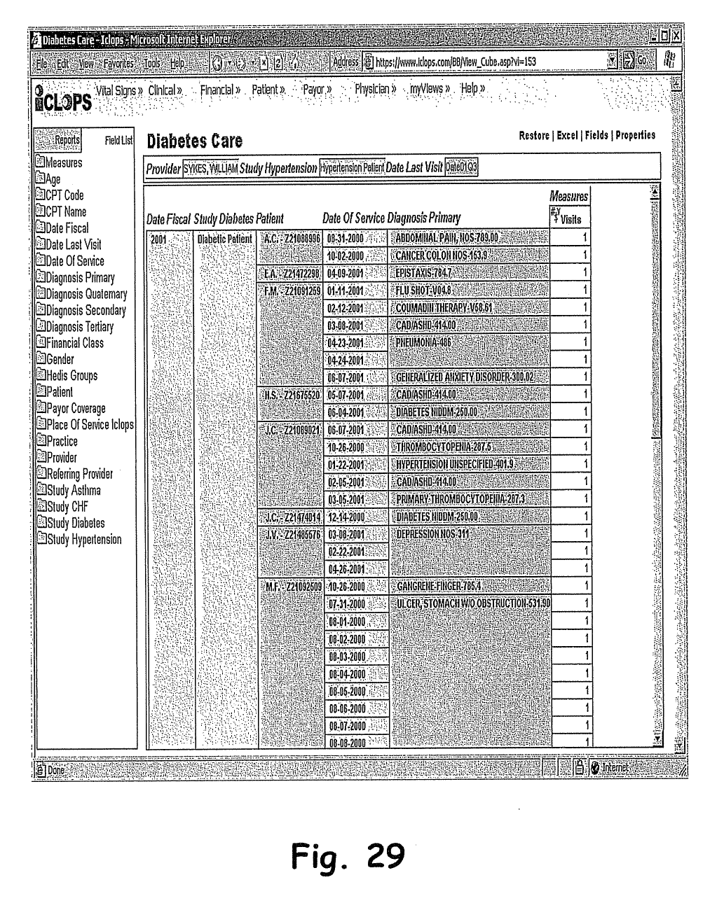

FIG. 28 is a screen shot of data shown in FIG. 27 including date of visit, according to an example. This view may be created by dragging the Date level of the Date of Service dimension into the Rows Area right of Patient. The resulting view depicted in FIG. 28 shows the diabetic-hypertensive patients whose last visit was in the third quarter of 2001, by name, how many visits to the practice they each had, when they visited, and the type of facility in which the visit occurred.

FIG. 29 is a screen shot of data shown in FIG. 28 including primary diagnosis, according to an example. This view may be created by dragging the Diagnosis Name level of the Primary Diagnosis dimension into the Rows Area right of Date of Service. The resulting view depicted in FIG. 29 shows the diabetic-hypertensive patients whose last visit was in the third quarter of 2001, by name, how many visits they each had, what the primary diagnosis was, when they visited, and the type of facility in which the visit occurred.

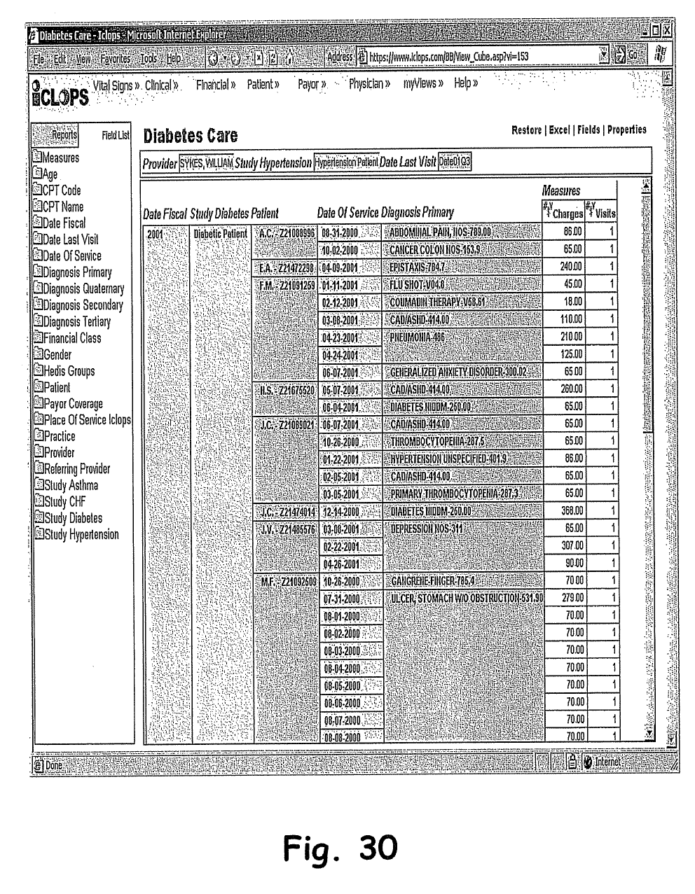

FIG. 30 is a screen shot of data shown in FIG. 29, including charge to patient, according to an example. This view may be created by dragging the Charges measure into the Measures Area of the view. The resulting view depicted in FIG. 30 shows the diabetic-hypertensive patients whose last visit was in the third quarter of 2001, by name, how many visits they each had, what the primary diagnosis was, when they visited, what the amount charged was, and the type of facility in which the visit occurred.

As shown with reference to FIGS. 21-30, a practice can use the system 400 to evaluate their clinical business operations and improve business performance. While the example above depicts how a practice may use the analytical data from the cubes 140 to evaluate diabetic patients, the practice may use the analytical data in a variety of other ways.

### Physician Scoring Example

In addition, the system 100 may be used to calculate a score that provides an indication of physician performance. The physician score is generally determined by analyzing data from multiple data sources. For example, data may be obtained from claims submitted by the physician's practice, either through a direct extraction from a practice management system or by collection from a third party, such as a hospital or a claims clearinghouse. The data may be used to identify an appropriate population of patients for measuring physician quality.

The patient population may be determined by analyzing the data to establish an initial registry of patients belonging to the conditions or patient populations being tracked (e.g., patients with diabetes, patients over the age of 65). The patient registry may identify patients who have been diagnosed with the particular condition and track the number of patient visits to the physician practice, regardless of the reason for the visit. Filters may be applied to the patient registry to remove patients who should not be included in measuring the performance of the physician for a variety of reasons. For example, the patient may be deceased, dismissed from the practice, moved away, not have the condition managed by the physician, and so on.

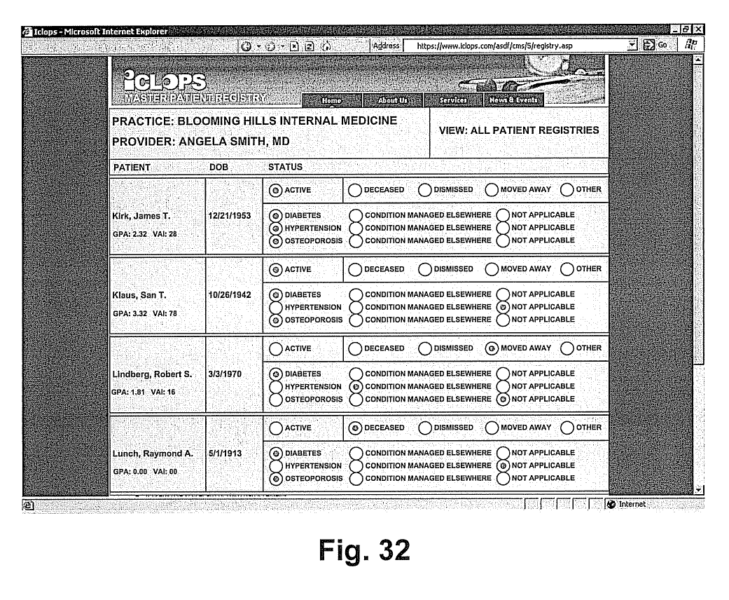

An example screen shot of a portion of a patient registry is depicted in FIG. 32. This example depicts a portion of Dr. Angela Smith's patient registry who is a doctor in the Blooming Hills Internal Medicine practice. Of the four patients listed in FIG. 32, two patients are active (i.e., Kirk and Klaus), while the other two patients (i.e., Lindberg and Lunch) are not active. The data for inactive patients may be filtered out during the calculation of a physician score for Dr. Smith. Additionally, the active patients may be filtered based on particular condition. For example, if Dr. Smith's physician score is to be based on her treatment of diabetes and/or osteoporosis, data from both of the active patients may be used. However, if Dr. Smith's physician score is to be based on her treatment of hypertension, Mr. Klaus' data may be filtered out before determining Dr. Smith's physician score.

A physician practice may review the patient registry using the system 400 or a secure web portal so that conditions, patient status, and management of the patient by the physician may be validated by the practice. Additionally or alternatively, a physician practice may use physician prompts to validate the patient registry. A physician prompt may be a document or on-line form used to collect data for condition-specific clinical processes, patient outcomes, or other characteristics, which may not available from the practice management system. For example, physician prompts may be used to collect:
Validation of the patient's status in the practice and verification of the patient's diagnosis;
Clinical process and patient outcome codes that serve as critical measures in the physician score; and
Stratification measures, such as whether a patient is a current smoker, whether an asthmatic has mild intermittent asthma, or if a heart failure patient has an ejection fraction less than 40%.

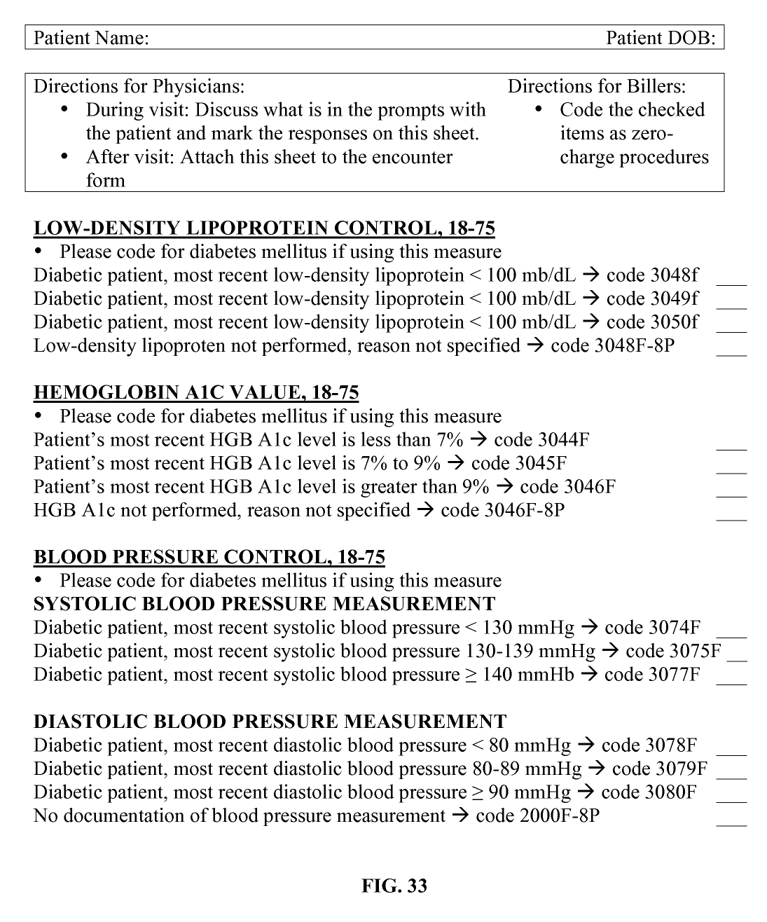

For paper-based practices, the physician prompts may be placed in a patient's chart. For practices with an electronic health record (EHR), an electronic physician prompt, similar to the paper-based one, may be included in the data capture process. The physician prompts serve to capture clinical data in a retrievable format. An example physician prompt for diabetes treatment is depicted in FIG. 33.

The physician prompts may be used to obtain “Control Measures” and “Clinical Process Measures.” The Control Measures may indicate the status of the patient's condition, and how well a condition is being controlled (e.g., in the case of diabetes whether the HgbA1C falls into one of three categories <7%, 7-9%, or >9%). For chronic diseases, the Control Measures may include measurements of blood sugar levels (HBA1C), blood pressure, and lipid levels. For surgery, the Control Measures may include a measure of the successful outcome of the surgery and lack of complications.

The Clinical Process Measures may be used to determine whether the physician followed appropriate clinical procedure in the management of the specific condition, for example, by examining the receipt of any code for a quality measurement in the previous 12 months. In the example of diabetes, if the physician has submitted any quality code for the HBA1C level (including if there was an exclusion modifier such as the patient refusing the test), the physician's score may be increased.

Clinical Process Measures and Control Measures may be established for any condition and/or patient population being assessed for physician quality. As a result, the physician score may be calculated using a subset of all services provided to the full patient population of a given physician. In one example, the physician score may be determined by examining critical points of care to patients who represent a critical or measurable component of the physician's patient base.

The calculation of the Control Measures and the Clinical Process Measures may provide a partial foundation in which to evaluate a physician's quality. A patient's status may be influenced by the care of the physician, but only if the patient adheres to prescribed treatment and lifestyle changes identified by the physician. To distinguish between physician-controlled outcomes and processes, and patient-controlled variables, a Visit Adherence Index (VAI) may be used when the physician services are visit-based, such as primary care physicians and cardiologists. The Visit Adherence Index may be used to create a multiplier to be applied to the Clinical Process Measures and/or the Control Measures.

The Visit Adherence Index may be used to gauge the patient's likelihood of returning to the physician's office for management of a disease conditions (i.e., planned visits) needed for management of the disease condition by the physician. The Visit Adherence Index may provide a comparison between practices regarding how likely the physician is able to manage the disease condition for the registry patients. To calculate the Visit Adherence Index, gaps between visits in the preceding twelve months and/or twenty-four months may be identified.

For example, diabetic patients in the patient registry may be expected to visit their physician every three months (90 days), except for patients with very good control of the disease (e.g., a hemoglobin A1C less than 7, a systolic blood pressure less than 130 mmHg, a diastolic blood pressure less than 90 mmHg, and an LDL less than 100 mg/dl), and without other risk factors or complications of diabetes. Variances of greater than 90 days (or in the case of well controlled diabetic patients 180 days) may be identified and the days above 90 tabulated. Visits that are for minor acute problems and/or for which the condition (e.g., diabetes) is not listed in one of the diagnosis categories, may be excluded from the analysis, as well as inpatient visits.

Patients with a single visit to the office are less likely to follow-up than patients who have established themselves with the practice. The Visit Adherence Index may be adjusted higher (e.g., doubled) for diabetic patients who have visited the office once and have not returned to the office within 90 days of the initial visit. Other adjustments may also be made to the Visit Adherence Index based on the likelihood of the patient adhering to the prescribed visit schedule.

In addition to the Visit Adherence Index, other adjustments may be made to the Clinical Process Measures and/or the Control Measures that reflect patient-controlled behaviors and refusal to participate in certain required tests. For example, adjustments may be made based on lifestyle choices, such as smoking status. Patients who choose to continue smoking have higher risk and poorer outcomes, in general. As another example, adjustments may be made based on income status. Patients in lower income levels have higher levels of chronic disease and poorer management levels of those conditions.

Patient assessment data may also be collected prior to determining the physician score. A patient prompt may be used to collect patient-specific data that may be used to assess the effectiveness of the physician management. The patient prompt is meant to enhance patient-centered care and be closely linked with other data elements to assist in physician (or other health care provider) performance improvement and patients becoming more informed consumers. An example patient prompt is depicted in FIG. 34.

The patient prompt, like the physician prompt, may be designed by an analysis of the patient's specific conditions or procedures. For example, a patient prompt for a surgical case may request that the patient respond to whether the actual outcome of the surgery matched the patient's expectations (for example, as conveyed to the patient by the physician), whether the patient experienced any complications, and whether the patient had appropriate pre-surgical education. As another example, a patient prompt for a patient with chronic disease may request the patient to respond to whether the patient believes that the physician's treatment will be effective, whether he or she is able to follow the required regimen, and whether the physician has adequately mentored the patient about the condition and the treatment.

The patient prompts may be designed to assure specific questions or issues have been addressed during the office visit as seen in FIG. 34. This type of patient prompt, which is referred to herein as a Type I patient prompt, queries patients about issues specific to the status of their care and may assist the physician in determining if certain factors may be creating a barrier to optimal outcomes. The design of the Type I patient prompts may vary based on different clinical conditions and the appropriate Type I patient prompt may be provided to patients identified as having a particular clinical condition in the patient registry. For example, a diabetic patient with poor control of his/her blood pressure may be requested to answer questions about medication adherence.

For paper-based practices, the Type I patient prompts may be placed in a patient's chart. For practices with an electronic health record (EHR), an electronic Type I patient prompt, similar to the paper-based one, may be included in the data capture process. At the time of the patient visit, the Type I patient prompt is provided to the patient to complete and review with the physician. After review of the completed Type I patient prompt, the physician may note on the form that the questions were reviewed and provide the completed prompt to the front desk/office manager to include this occurrence on the patient registry. Alternately, the physician might enter a CPT code indicating form completion (this might be incorporated in the physician prompt process).

The Type I patient prompts may provide documentation of specific investigation of high-risk patients. In the case of patients with poor visit adherence or refusal of process measures, the Type I patient prompt may serve to confirm patient understanding and/or identify hidden reasons for poor patient involvement in self-management. Additionally or alternately, the Type I patient prompt may be used to secure patient commitment to action plans and/or goal setting for health management. The Type I patient prompt may also serve to alert patients to upcoming mailing from the physician and query about preferred means of out of office communication (e.g., will the patient accept email message, phone text messages, or must paper mail be used).

Additional patient prompts may also be used. For example, anonymous patient prompts may be used to obtain patient assessment of their physician and the care provided by the office. This type of patient prompt, which is referred to herein as a Type II patient prompt, is designed to capture patient feedback. The Type II patient prompts may also vary based on different clinical conditions and the appropriate Type II patient prompt may be provided to patients identified as having a particular clinical condition in the patient registry.

The Type II patient prompt data may be collected at the office, subsequently entered by the patient securely online, or subsequently mailed to a third party for entry. The results may be scanned, entered into the database, and subsequently analyzed. The content of the Type II patient prompt is very focused toward the physician's performance in the eyes of the patient. With the example of the surgical patient, the provision of and value of pre- and post-operative instructions may also be assessed. The patient's assessment of complications and outcomes may be compared (e.g., on an aggregate basis) with the physician's assessment to determine discrepancies.

The patient prompts may be distinguished from standard patient satisfaction surveys in the following features:
They are produced from registry data and are specific to the care and problems the patient has. Even for Type II patient prompts, where the patient data may be collected anonymously, the specific issues and patient conditions are known and the resulting analysis is therefore specific to those patient populations and issues.
The language of the patient prompts (if other than English) may be varied based upon practice entry into the online patient registry.
The results of the patient prompts are integrated into the database for the physician and may serve to adjust and contribute to performance measurements for the individual physician.

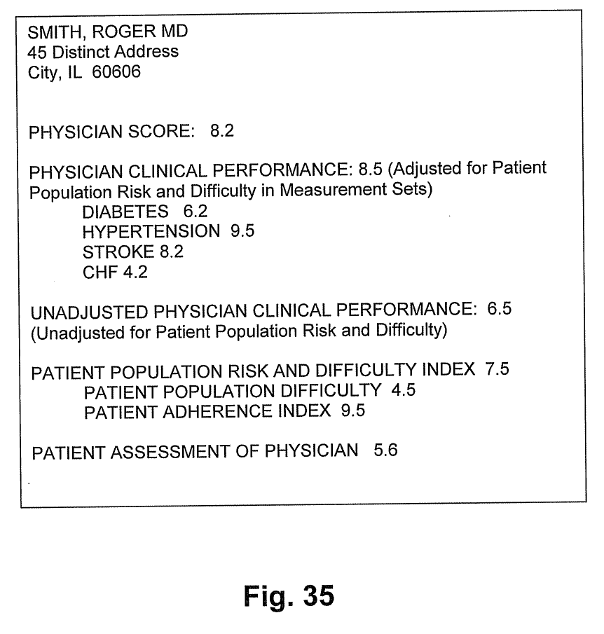

FIG. 34 is an example physician score report. As shown in FIG. 35, the physician score may be reported both as an aggregate score and individual scores for each measurement set chosen by the physician. However, the report may be designed in a variety of ways, including depicting only the aggregate score or only the individual scores. Preferably, the measurement set includes subcomponents, depending upon the measures. For example, the subcomponents may include Physician Clinical Performance, Patient Risk, and Patient Assessment. Table 1 below shows a description of each of these subcomponents.

TABLE 1

| | | |
|---|---|---|
| Description | Components | Adjustments/Multipliers |

COMPONENT 1: PHYSICIAN CLINICAL PERFORMANCE

| | | | |
|---|---|---|---|
| Control | Aggregate patient | Condition; outcome- | From Component 2, adjust |
| Measures | outcomes index for | related Cat II codes | for results good and |
| | major benchmarks (by | (plus intermediate) | intermediate, poor results |
| | measurement set), when | | not counted. Range of |
| | available, at 3 intervals | | adjustment may be up to |
| | related to the guidelines: | | 50% above base. |
| | above, below, and | | |
| | intermediate. For | | |
| | procedures limit | | |
| | reporting to low risk | | |
| | patients, and query | | |
| | about absence of | | |
| | complications. | | |
| Clinical | Aggregate physician | Condition; process- | Multiplier derived from |
| Process | adherence to process- | related Cat II codes | Visit Adherence Index |
| Measures - | type Category II codes | reported divided by the | (when applicable) |
| | | number of visits or | |
| | | occurrences (the | |
| | | opportunities for code | |
| | | capture) | |
| Efficiency | Measures cases where | | |
| Assessment | an adverse outcome for | | |
| Measures | patients related to a | | |
| | process if there is no | | |
| | Clinical Process | | |
| | Measure reported | | |

COMPONENT 2: PATIENT POPULATION RISK AND DIFFICULTY INDEX

| | | | |
|---|---|---|---|
| Visit | Aggregate patient | Condition; visits per | Zip codes |
| adherence | adherence (by | year; visit spacing, type | Patient comorbidity |
| index | Measurement set) to | of visit; place of visit | Patient complications |
| | visit guidelines, time | | (from basic condition) |
| | quantified to ensure that | | Patient risk (Cat II |
| | they are spaced apart & | | scores above norm) |
| | filtered out for acute and | | Multiplier derived from |
| | hospital visits - must be | | Visit Adherence Index |
| | able to be trended | | |
| Patient | Existing smoking status- | | |
| Lifestyle | current smoker | | |
| Factors | | | |
| Preventive | Absence of age- | | |
| services | appropriate screenings, | | |
| | e.g. Mammography, | | |
| | colon cancer screening | | |
| Clinical | Patient refusal to | | |
| guidelines | cooperate as indicated | | |
| adherence | by Cat II refusal codes | | |

COMPONENT 3: PATIENT ASSESSMENT

| | | | |
|---|---|---|---|
| Physician | Measures how well the | Management; | Patient attitudes survey - |
| Management | patient believes that the | professional | results may adjust scores |
| Survey - 75% | physician manages | competence; listening; | for effectiveness and |
| | his/her condition | effectiveness of | management |
| | | education and | |
| | | application; motivation; | |
| | | access; professionalism | |
| | | and respectfulness | |
| Patient | Measures patient | Barriers to care | |
| Attitudes | attitudes about their | | |
| Survey - 25% | conditions and therapy | | |

Generally, the physician score is calculated by determining a Physician Clinical Performance index and adjusting this value downward and/or upward by the using Patient Risk, Efficiency Adjustment, and Patient Assessment. The subcomponents may be combined to determine the physician score. The physician score may be used by the physician to improve the quality of service at the physician's practice. Additionally, the physician score may be used by others for selecting a physician.

It should be understood that the illustrated embodiments are examples only and should not be taken as limiting the scope of the present invention.

We claim:

1. A method for calculating a score indicative of a physician's clinical performance or quality of care, comprising:
receiving client data;
analyzing the client data to identify a patient population treated by the physician;
analyzing the client data to calculate control measures for the patient population, wherein the control measures are indicative of a status of a condition of a patient within the patient population;
analyzing the client data to calculate clinical process measures for the patient population, wherein the clinical process measures are indicative of a procedure in the management of a specific condition; and
calculating the score indicative of the physician's performance using (i) the patient population, (ii) the control measures, and (iii) the clinical process measures.

2. The method of claim 1, further comprising analyzing the client data to calculate a visit adherence index, wherein the value of the visit adherence index is indicative of a patient's likelihood of returning to the physician's office for a planned visit.

3. The method of claim 2, further comprising using the visit adherence index to modify the value of the control measures.

4. The method of claim 2, further comprising using the visit adherence index to modify the value of the clinical process measures.

5. The method of claim 1, further comprising:
analyzing the client data to identify patient-controlled behaviors; and
using the identified patient-controlled behaviors to modify the clinical process measures.

6. The method of claim 1, further comprising:
analyzing the client data to identify patient-controlled behaviors; and
using the identified patient-controlled behaviors to modify the control measures.

7. The method of claim 1, wherein receiving client data further comprises receiving a patient assessment data.

8. A system for data extraction and conversion of client data for use in calculating a score indicative of a physician's performance, comprising:
a database arranged to (i) receive the client data, (ii) analyze the client data to identify a patient population treated by the physician, (iii) analyze the client data to calculate control measures for the patient population, wherein the control measures are indicative of a status of a condition of a patient within the patient population, (iv) analyze the client data to calculate clinical process measures for the patient population, wherein the clinical process measures are indicative of a procedure in the management of a specific condition, (v) calculate the score indicative of the physician's performance using (a) the patient population, (b) the control measures, and (c) the clinical process measures.

9. The system of claim 8 wherein the database is further arranged to analyze the client data to calculate a visit adherence index, wherein the value of the visit adherence index is indicative of a patient's likelihood of returning to the physician's office for a planned visit.

10. The system of claim 9, wherein the database is further arranged to utilize the visit adherence index to modify the value of the control measures.

11. The system of claim 9, wherein the database is further arranged to utilize the visit adherence index to modify the value of the clinical process measures.

12. The system of claim 8, wherein the database is further arranged to:
analyze the client data to identify patient-controlled behaviors; and
utilize the identified patient-controlled behaviors to modify the clinical process measures.

13. The system of claim 8, wherein the database is further arranged to:
analyze the client data to identify patient-controlled behaviors; and
utilize the identified patient-controlled behaviors to modify the control measures.

14. The system of claim 8, wherein the client data comprises a patient assessment data.

15. A method for updating a patient registry database, comprising:
sourcing an analysis database with claims data;
analyzing the claims data within the analysis database to identify a first set of information from the group consisting of a patient identification, condition registries corresponding to patient population, the patient's last known participation status, last known status of condition registries, date and nature of the last known condition registry trigger, the patient's last known date of service with that practice, and last known prompt responses;
importing the first set of information from the analysis database into the patient registry database, so as to create a second set of information;
updating the second set of information; and
synchronizing the first set of information and the second set of information.

16. The method of claim 15, wherein updating the second set of information comprises receiving an instruction from a user to modify the second set of information.

17. The method of claim 15, further comprising:
analyzing the second set of information to determine whether a patient's status within the condition registries has changed.

18. The method of claim 17, further comprising generating a prompt when the patient's status within the condition registry has changed.

19. The method of claim 17, further comprising printing a patient communication letter when the patient's status within the condition registry has changed.

20. The method of claim 16, wherein the instruction from the user is entered using a web interface.

21. A system for client access to analytical data for use in evaluating business operations, comprising in combination:
a client device operable to fetch and display a view;
a database server including:
a system management database, wherein the system management database includes client authorization data, wherein the client authorization data includes a database record associated with each authorized user that indicates which menus, views, and databases are available to the authorized user,
wherein the system management database further includes measure and registry definition information, wherein the measure and registry definition information identifies measures and registries to which a patient belongs; and
a server including an application operable to receive a request from the client device for a view, select the requested view, verify that a user of the client device is authorized to access the view by querying the database server, and if the user is authorized, transmit the view to the client device, wherein the view includes the measure and registry definition information,
wherein the client device is further operable to (i) receive an input from the user, and (ii) in response to the input from the user, update a record in a master patient registry database.

22. The system of claim 21, wherein the input from the user comprises a clinical value.

23. The system of claim 22, wherein the input from the user further comprises a quality code.

24. The system of claim 21, wherein the record in the master patient registry corresponds to a patient.

25. The system of claim 21, wherein the client device is operable to receive a drag and drop instruction to add a measure to a current view.

26. The system of claim 23, wherein the input further comprises a single combination a quality code and a clinical value.

27. The system of claim 21, wherein the record in the master patient registry corresponds to a group of patients.

28. The system of claim 8 wherein the database is further arranged to analyze the client data to identify patients who meet a criteria for quality measurement, where the criteria include age, prior diagnoses, current diagnoses, or gender, to form one or more patient registries.

29. The system of claim 28 wherein the patent registries may be specified into subcomponent classes based on a measurement reporting period and a source of a measure, where the source of measure includes a commercial insurer or government payer, and where a distinct measurement of results for each subcomponent class may be provided.

30. The system of claim 8 wherein the database is further arranged to analyze the client data to reveal clinical conditions and risks for each patient.
